(19) United States
(12) Patent Application Publication
(10) Pub. No.: US 2002/0049709 A1
(43) Pub. Date: Apr. 25, 2002

(54) Status information sharing system and user terminal device for sharing status information of user handling plurality of user terminal devices, and server device for managing user terminal devices, as well as control method thereof and storage medium storing program for method

(76) Inventors: Takashi Miyasaki, Kanagawa (JP); Ken Sakakibara, Tokyo (JP); Yoshihisa Tadokoro, Tokyo (JP); Masami Kato, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/848,292

(22) Filed: May 4, 2001

(30) Foreign Application Priority Data
May 10, 2000 (JP) 137305/2000
May 10, 2000 (JP) 137306/2000
Jun. 2, 2000 (JP) 166054/2000

(51) Int. Cl. G06F 7/00

(52) U.S. Cl. 707/1

(57) ABSTRACT

A status information sharing system for sharing status information of users who handle a plurality of user terminal devices is provided, wherein the status information sharing system generates accurate latest status information, for example, a work status, a presence status and a schedule based on a status of a user or a schedule in schedule information of the user and provides the other users of the generated latest status information.

### BACKGROUND OF THE INVENTION

1. Field of the Invention

The present invention relates to a status information sharing system, a status information sharing method and a storage medium for displaying status information, such as a work status and a presence status of a user, on an information processing device connected to a network.

2. Related Background Art

In recent years, with the development of networks, an environment in which terminals connected to a network can share information has been provided. In such a network environment, there is a need for realizing efficiency in work and communication by each user sharing status information of the other users through a terminal and confirming work statuses and presence statuses of the other users to communicate with.

Thus, a system has been proposed which has client terminals of a plurality of users and a server device connected to a network, and with which the users input individual schedules on the client terminals, the server device manages an individual schedule of each user to distribute the individual schedules of the other client terminals to each client terminal.

However, in such a conventional system, there is a problem in that, even if there is a change in a schedule included in an individual schedule, a user may not input the change of the individual schedule on the user's client terminal, which makes a schedule described in the individual schedule to be distributed to client terminals incorrect.

For example, there is a problem in that, if a meeting of a user is extended, the user cannot input on the user's client terminal that the meeting described in the user's individual schedule is extended because the user is present at the meeting, and an individual schedule with a schedule different from an actual one is distributed to client terminals of the other users.

In addition, for example, there is a problem in that, if a user makes an irregular schedule such as a rest, the user needs to change an individual schedule on the user's client terminal every time such a schedule is made, thus operations for the change are complicated for the user or the user forgets to change the user's individual schedule.

### SUMMARY OF THE INVENTION

The present invention has been devised in view of the above problems, and it is an object of the present invention to provide a status information sharing system in which a plurality of user terminal devices and a server device are connected on a network, and which is capable of providing accurate status information of a user who handles a user terminal device, for example, a work status, a presence status or a schedule, to the other users.

Other objects and features of the present invention will be apparent from the following descriptions in the specification and drawings, in which like reference characters designate the same or similar parts throughout the figures thereof.

### BRIEF DESCRIPTION OF THE DRAWINGS

FIG. 1 is a block diagram showing an example of a configuration of a status information sharing system in accordance with the present invention;

FIG. 2 is a block diagram showing an example of a functional configuration of a server device of the status information sharing system in accordance with the present invention;

FIG. 3 is a block diagram showing an example of a functional configuration of a user terminal device of the status information sharing system in accordance with the present invention;

FIG. 4 is a flow chart showing processing of the server device of the status information sharing system in accordance with the present invention;

FIG. 5 is a flow chart showing the processing of the server device of the status information sharing system in accordance with the present invention;

FIG. 6 is a flow chart showing processing of the user terminal device of the status information sharing system in accordance with the present invention;

FIG. 7 is a block diagram showing an example of a configuration of the status information sharing system in accordance with the present invention;

FIG. 8 is a block diagram showing an example of a functional configuration of the server device of the status information sharing system in accordance with the present invention;

FIG. 9 is a flow chart showing processing of the server device of the status information sharing system in accordance with the present invention;

FIG. 10 is a flow chart showing the processing of the server device of the status information sharing system in accordance with the present invention;

FIG. 11 is a flow chart showing processing of the user terminal device of the status information sharing system in accordance with the present invention;

FIG. 12 is a flow chart showing the processing of the user terminal device of the status information sharing system in accordance with the present invention;

FIG. 13 is a block diagram showing an example of a configuration of the status information sharing system in accordance with the present invention;

FIG. 14 is a block diagram showing an example of a functional configuration of the server device of the status information sharing system in accordance with the present invention;

FIG. 15 is a block diagram showing an example of a software functional configuration of the server device of the status information sharing system in accordance with the present invention;

FIG. 16 is a block diagram showing an example of a hardware configuration of the user terminal device of the status information sharing system in accordance with the present invention;

FIG. 17 illustrates a status in which devices are installed in a home office where a user of the status information sharing system in accordance with the present invention works;

FIG. 18 illustrates a configuration of software for the user terminal device of the status information sharing system in accordance with the present invention;

FIG. 19 illustrates a screen for realizing the functions of the status information sharing system on a virtual distributed office system of the status information sharing system in accordance with the present invention;

FIG. 20 is a block diagram showing an example of a functional configuration of the server device of the status information sharing system in accordance with the present invention;

FIG. 21 is a table showing training data stored in training data storing means in accordance with the present invention;

FIG. 22 is a flow chart showing processing of the server device of the status information sharing system in accordance with the present invention;

FIG. 23 is a flow chart showing processing of the user terminal device of the status information sharing system in accordance with the present invention;

FIG. 24 illustrates a status information table in which a plurality of pieces of status information and reliability of the information are added in the status information sharing system in accordance with the present invention;

FIG. 25 is a block diagram showing an example of a configuration of the status information sharing system in accordance with the present invention;

FIG. 26 is a block diagram showing an example of a configuration of the server device of the status information sharing system in accordance with the present invention;

FIG. 27 is a block diagram showing an example of a configuration of the user terminal device of the status information sharing system in accordance with the present invention;

FIG. 28 is a flow chart showing processing of the server device of the status information sharing system in accordance with the present invention;

FIG. 29 is a flow chart showing procedures for processing operations of user status recognizing means of the status information sharing system in accordance with the present invention;

FIG. 30 is a flow chart showing procedures for processing operations of image recognizing means of the status information sharing system in accordance with the present invention;

FIG. 31 is a flow chart showing procedures for processing operations of the image recognizing means of the status information sharing system in accordance with the present invention;

FIG. 32 is a flow chart showing procedures for processing operations of the user status recognizing means of the status information sharing system in accordance with the present invention;

FIG. 33 is a flow chart showing procedures for processing operations of the image recognizing means of the status information sharing system in accordance with the present invention;

FIG. 34 is a flow chart showing procedures for processing operations of the image recognizing means of the status information sharing system in accordance with the present invention;

FIG. 35 is a flow chart showing procedures for processing operations of the image recognizing means of the status information sharing system in accordance with the present invention;

FIG. 36 is a flow chart showing procedures for processing operations of the image recognizing means of the status information sharing system in accordance with the present invention;

FIG. 37 is a table showing formats of schedule information of the status information sharing system in accordance with the present invention;

FIG. 38 is a table showing information concerning update frequencies for each work type saved in database means of the status information sharing system in accordance with the present invention;

FIG. 39 is a table showing information concerning work types saved in the database means of the status information sharing system in accordance with the present invention;

FIG. 40 illustrates a screen for setting update frequencies of the status information sharing system in accordance with the present invention;

FIG. 41 is a flow chart showing procedures for processing operations of the server device of the status information sharing system in accordance with the present invention;

FIG. 42 is an explanatory view showing an example of a configuration of contents stored in a storage medium storing a program and related data in accordance with the present invention; and

FIG. 43 is an explanatory view showing an example of a concept of supplying the program and the related data in accordance with the present invention from the storage medium to a device.

### DESCRIPTION OF THE PREFERRED EMBODIMENTS

Embodiments of the present invention will be hereinafter described in detail with reference to the accompanying drawings.

First Embodiment

In this embodiment, descriptions will be made concerning the case in which a status information sharing system is realized by connecting a plurality of user terminal devices to a server device simultaneously via a communication line network. In addition, descriptions will be particularly made concerning the case in which latest status information is notified to each user terminal device based on a last schedule in schedule information of a user.

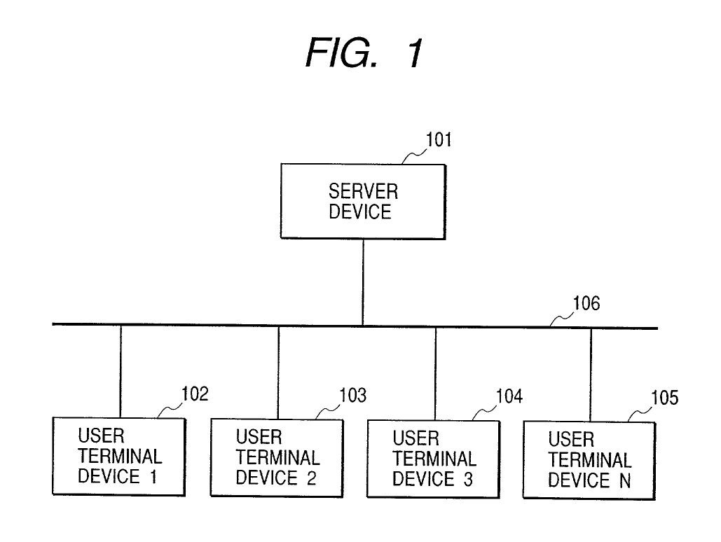

FIG. 1 is a block diagram showing an example of a configuration of the status information sharing system in accordance with this embodiment. As shown in FIG. 1, the status information sharing system in accordance with the present invention is provided with a server device 101, a user terminal device 1•102, a user terminal device 2•103, a user terminal device 3•104, a user terminal device N•105 and a communication line network 106.

The user terminal devices 102 to 105 are workstations, personal computers or the like provided with a communication function, and are connected to the communication line network 106. The user terminal devices 102 to 105 are connected to the server device 101 via the communication line network 106, and can communicate with each other.

Further, the status information sharing system shown in FIG. 1 may be configured with the user terminal devices 102 to 105 and the server device 101 arranged in an identical office, or may be configured with the user terminal devices 102 to 105 and the server device 101 geographically separated.

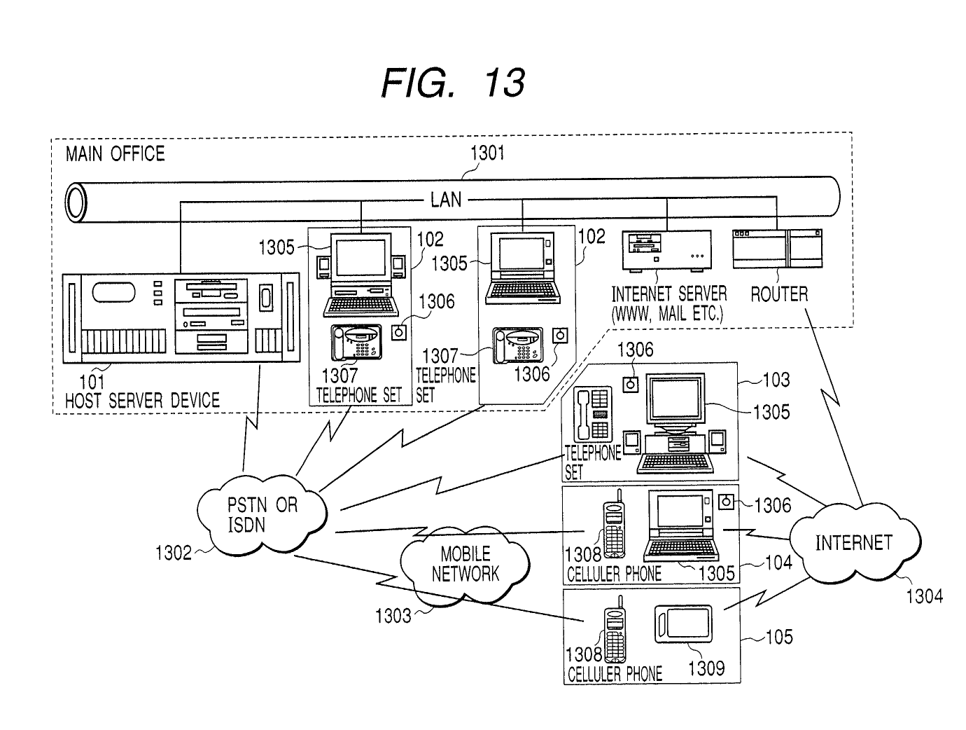

FIG. 13 shows a configuration of an example of a distributed office system in this embodiment. In this distributed office system, the server device 101 is installed in a main office (a head office or the like of a company or one of various corporations that introduces a distributed office), and is connected to an LAN (Local Area Network) 1301 in the main office as shown in FIG. 13. This LAN 1301 may be constructed with the user terminal devices 102 to 105 and the server device 101 arranged in an identical office, or may be constructed with the user terminal devices 102 to 105 and the server device 101 geologically separated.

The user terminal device 102 is a user terminal device for a worker employed in a main office, and is a combination of a personal computer 1305, software for user terminal device 1306, a telephone 1307, and other devices or the like. The telephone 1307 is connected to the server device 101 via a PSTN line (public subscriber telephone line) or an ISDN line 1302. In addition, a personal computer 1305 is connected to the server device 101 via the LAN 1301.

The user terminal device 103 is a user terminal device for a worker working in a home office, and is a combination of the personal computer 1305, the software for user terminal device 1306, the telephone 1307, and other devices or the like. The telephone 1307 is connected to the server device 101 via the PSTN line (public subscriber telephone line) or the ISDN line 1302. In addition, the personal computer 1305 is connected to the server device 101 via the Internet 1304.

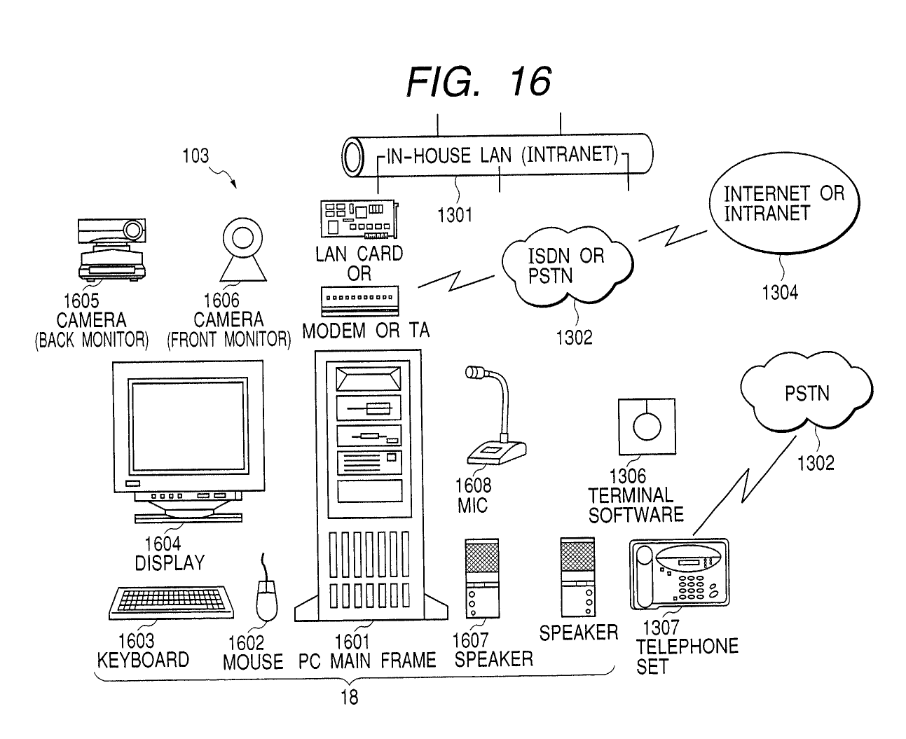

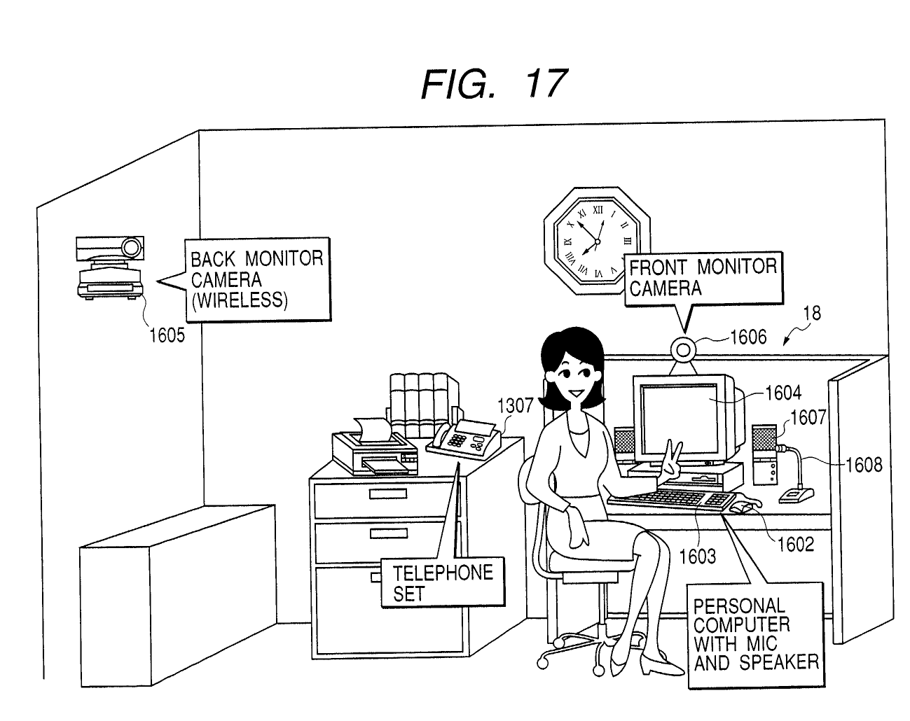

A hardware configuration of the user terminal device 103 will be described in detail with reference to FIG. 16. The user terminal device is configured by two types of video cameras 1605 and 1606 (for a back monitor and a front monitor) connected to image input terminals of a main body 1601 of the personal computer 1305, in addition to the software 1306 for terminal device and the telephone 1307. However, only one of the video cameras 1605 and 1606 may exist. In addition, a mouse 1602, a keyboard 1603, a display 1604, a speaker 1607, a microphone 1608 and the like are connected to input/output terminals corresponding to each device provided in the personal computer main body 1601, respectively. In addition, FIG. 17 shows a state in which the devices shown in FIG. 16 are actually installed in a home office where a user works.

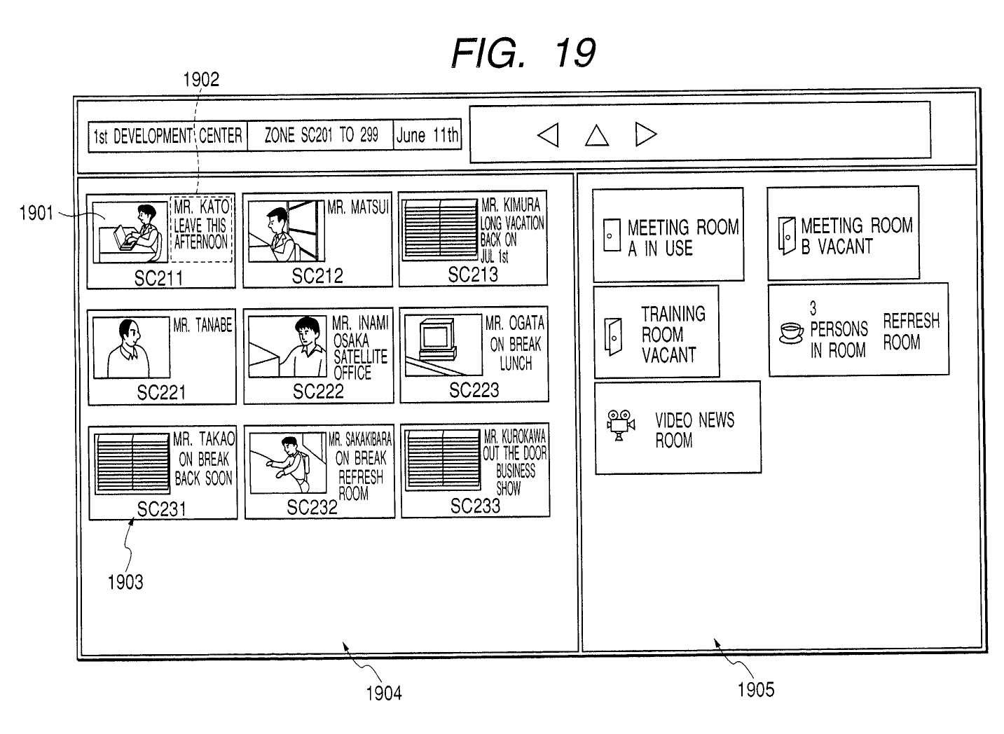

Usually, when a user is on duty, an existing position of the user is within this office view, and an office view shown in FIG. 19 is displayed on the personal computer 1305 that the user uses.

FIG. 19 illustrates a screen for realizing functions of the status information sharing system in the virtual distributed office system (hereinafter referred to as the office view). Reference numeral 1901 denotes an image showing a work status of another user. Reference numeral 1902 denotes a work status data display unit on which character information being work status data of the user is displayed. A destination and a schedule of the user is displayed on the work status data display unit 1902. Reference numeral 1903 is figurative image indicating a virtual private room office space of the user. A virtual private room office of the user consists of these three elements. Further, although nine private room offices are displayed on an identical screen in this embodiment, the number of private room offices may be more or less than nine. Here, an entire display space 1904 is designated as a private room office area (virtual office area). In addition, a blank space between a private room office and an adjacent private room office is a virtual corridor part.

The image 1901 showing the work status of the user displayed as a part of the private room office is an image photographed by the back monitor camera 1605 and the front monitor camera 1606 that are provided in the user terminal device used by the user.

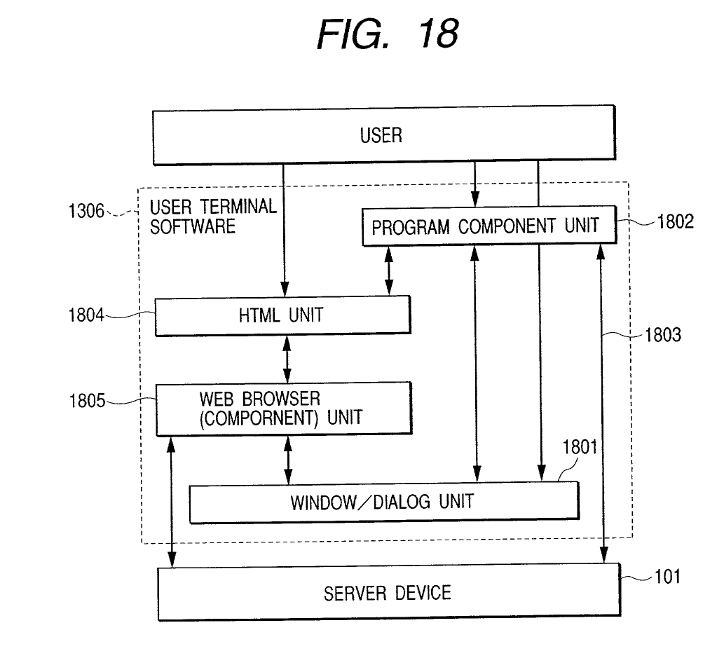

Operations for processing this image will be described. An photographed image is inputted in the personal computer 1305 from each camera via the video input terminal of the personal computer main body 1601, compressed and encoded as an compressed image of the QCIF format (176×144 pixels) by an image compressing and sending program component of a program component unit 1802, and promptly transferred to the server device 101 via a signal line 1803 (see FIG. 18).

The host server device 101, having received the compressed image, transfers the image to an SPU 1402 by an operation of each piece of software in a server manager unit 1501, an SPU access library unit 1503 and a driver unit 1505.

The SPU 1402 applies image processing to this compressed image for reducing its sizes in vertical and horizontal direction to one half, respectively, using a software program for compressed image reduction processing function stored in advance in an image processing function program storage unit provided in the SPU 1402. Then, the SPU 1402 generates a reduced compressed image of 88×72 pixels, and sends the reduced compressed image to all user terminal devices other than the user terminal device that photographed this image via the server manager unit 1501.

These user terminal devices display the received reduced compresses image as an image of work statuses of the private room offices on each screen using an image expansion display program component of the program component unit 1802.

In this way, a reduced compressed image is generated based on an original compressed image and is sent to the other user terminal devices, thereby realizing acceleration of an update frequency (frame rate) of an image of each user's work status to be displayed on each private office on the screen of each user terminal device. That is, it is possible to accelerate a frame rate of an image displayed in a private room office to the order to 4 fps (frame per second) by this compressed image generation processing, while the frame rate is, for example, 1 fps if the reduced compressed image generation processing is not performed in the SPU 1402. However, an actual frame rate depends on various factors such as a sending speed of the Internet to be used.

In addition, the user terminal device 1306 is a user terminal device for a worker working at a mobile office, and is a combination of a portable personal computer 1305, software for user terminal apparatus 1306, a cellular phone 1308, other devices or the like. The cellular phone 1308 is connected to the server device 101 via a mobile communication network 1303 and the PSTN line (public subscriber telephone line) or the ISDN line 1302. In addition, the personal computer 1305 is connected to the server device 101 via the Internet 1304.

Reference numeral 1307 is a user terminal device for a worker working at a mobile office, and is a combination of a general purpose portable information terminal 1309 incorporating a World Wide Web browser and the cellular phone 1308. The cellular phone 1308 is connected to the server device 101 via the mobile communication network and the PSTN line (public subscriber telephone line) or the ISDN line. In addition, the portable information terminal 1309 is connected to the server device 101 via the Internet 21.

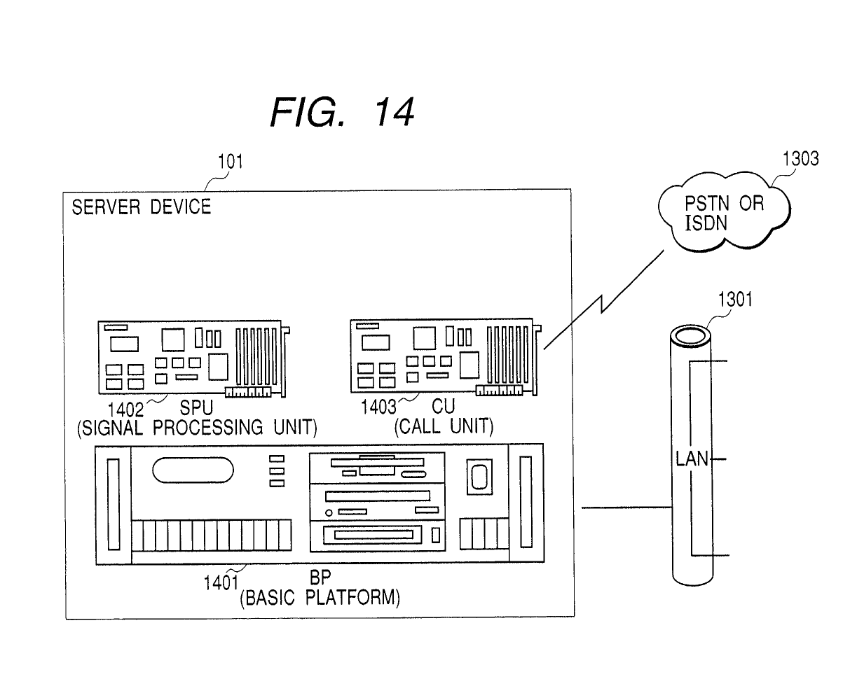

A hardware configuration of the server device 101 will now be described with reference to FIG. 14. A BP (Basic Platform) 1401 is a PC server device. The SPU (signal Processing Unit) 1402 is a parallel DSP (Digital Signal Processor) signal processing board. A CU (Call Unit) 1403 is a telephone line board (Computer Telephony Board). The BP 1401 is connected to the LAN 1301 in the main office via an LAN network board. The CU 1403 is connected to the PSTN line or the ISDN line 1303.

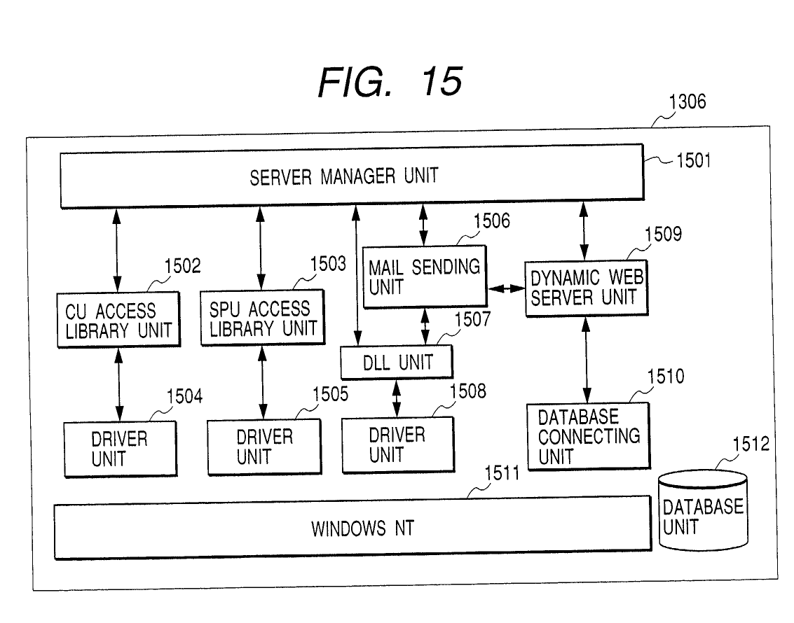

In addition, a software configuration of the server device 101 will now be described with reference to FIG. 15. Further, software included in the server device 101 includes a software program that is developed using such as the C++ language and existing software programs, and employs the Windows NT (registered trademark of Microsoft Corporation in the United States) as an OS (Operating System). In FIG. 15, reference numeral 1501 denotes a server manager unit, reference numeral 1502 denotes a CU access library unit, reference numeral 1503 denotes an SPU access library, reference numerals 1504, 1505 and 1508 denote driver units, reference numeral 1506 denotes a mail sending unit, reference numeral 1507 denotes a DLL (Dynamic Link Library) unit, reference numeral 1509 denotes a dynamic Web server unit, reference numeral 1510 denotes a database connector unit, reference numeral 1511 denotes the Windows NT (registered trademark of Microsoft Corporation in the United States), and reference numeral 1512 denotes a database unit.

In addition, a configuration of the software for user terminal device 1306 will now be described with reference to FIG. 18. Further, the software for user terminal device 1306 includes a software program that is developed using such as the C++ language and existing software programs, and employs the Windows 95 (registered trademark of Microsoft Corporation in the United States) as an OS (Operating System). In FIG. 18, reference numeral 1801 denotes a Window/Dialog unit, reference numeral 1802 denotes a program component unit, reference numeral 1803 denotes a signal line, reference numeral 1804 denotes an HTML unit, and reference numeral 1805 denotes a Web Browser (component) unit.

Moreover, describing the above-mentioned configuration more in detail, a server process (hereinafter referred to the server) S for sharing status information among the user terminal devices (102 to 105) is installed in the server device 101, and the server S always operates. Status information of each user sharing the status information is stored in the server S. A table storing the status information in the server S is referred to as a status information table. In addition, it is assumed that the status information includes information indicating a status of a user such as a name of a user, a presence status, a work status, a status of input in an input device, a name of an operating application, availability of contact, an address, a location, a contact, images, voices or the like.

On the other hand, a client 1, a client 2, . . . , and a client N being client processes (hereinafter referred to as the clients) for sharing status information of each user are installed in the user terminal devices 102 to 105, respectively. A user activates a client X (0<X<N+1) in the user's terminal device among the terminal devices (102 to 105), and makes connection with the server S of the server device 101. Further, the client X for sharing status information of a user may be installed in a terminal provided in the server S.

Further, in this embodiment, the user terminal devices 102 to 105 have user status recognizing means for recognizing presence status or the like of a user, and the server device 101 has schedule information storing means for storing schedule information of each user.

The server S installed in the server device 101 will be hereinafter described.

The server S collectively manages schedule information of a group consisting of all users or a part of users connected to a network, converts the schedule information to status information, and sends latest status information of each of the user terminal devices 102 to 105 to the other user terminal devices.

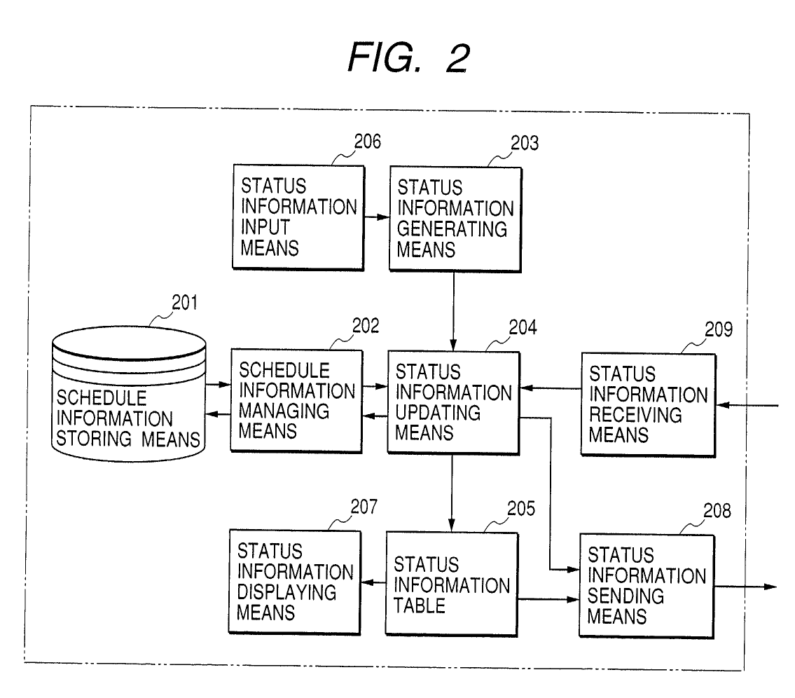

A functional configuration of the server S will be hereinafter described with reference to a block diagram of FIG. 2. The server S is provided with schedule information storing means 201, schedule information managing means 202, status information generating means 203, status information updating means 204, a status information table 205, status information input means 206, status information displaying means 207, status information sending means 208 and status information receiving means 209.

The schedule information storing means 201 stores schedule information of each user. Schedule information of a user is written in or read from the schedule information storing means 201 in accordance with a request from the schedule information managing means 202.

The schedule information managing means 202 operates and manages the schedule information storing means 201. The schedule information managing means 202 writes schedule information of a user in the schedule information storing means 201 or deletes schedule information therefrom based on the status information received by the status information receiving means 209 in accordance with a request from the status information updating means 204. In addition, the schedule information managing means 202 reads schedule information from the schedule information storing means 201 and converts the schedule information to status information.

The status information generating means 203 generates a status information operating command composed of a command for operating the status information and the schedule information inputted from the status information input means 206, a command for operating a server and the like, and a status information signal composed of the inputted status information of a user.

The status information updating means 204 will be hereinafter described.

The status information updating means 204 conducts processing based on the status information signal of a user received from the status information generating means 203 or the status information receiving means 209. For example, if the received status information signal includes a status information update command as a status information operating command, the status information updating means 204 updates the status information stored in the status information table 205 based on the status information included in the status information signal. At this point, the status information updating means 204 confirms with the schedule information managing means 202 if present and last schedules exist in the schedule information of the user. Then, the status information updating means 204 applies processing to the schedule information managing means 202 and the status information table 205 based on presence or absence of these schedules and the status information included in the received status information signal, and updates the status information. For example, in the case in which a present schedule does not exist but a last schedule exists in schedule information of a user, if the status information of the user indicates absence, it is considered that the last schedule is prolonged. Thus, the status information updating means 204 transfers a schedule information operating command for automatically extending the last schedule of the user to the schedule information managing means 202. Then, the schedule information managing means 202 having received the schedule information operating command from the status information updating means 204 writes the extended schedule in the schedule information stored in the schedule information storing means 201. In addition, the status information updating means 204 converts the schedule information, in which the extended schedule is written, to status information, and updates the status information stored in the status information table 205 with this converted status information. Further, it is also possible to set the schedule information managing means 202 not to automatically write a schedule in schedule information.

In addition, if the status information of the status information signal received by the status information updating means 204 indicates absence of a user, the status information updating means 204 counts time during which the user is continuously absent from the office. If present and last schedules do not exist in the schedule information of the user and a presence status of the received status information of the user indicates absence, the status information updating means 204 adds the counted absence time to the status information, and updates the status information stored in the status information table 205.

In addition, if a user sets a default absence state (rest, smoking, rest room or the like) in advance, the status information updating means 204 adds this default absence state in the status information, and updates the status information stored in the status information table 205. Further, it is also possible to combine a counted absence time and a default absence state to have status information of “smoking: absent for 5 minutes”. In addition, it is also possible to set a default absence state according to a counted absence time. For example, if an absence time is 15 minutes, the default absence state can be set as “smoking”, and if an absence time is 5 minutes, the default absence state can be set as “rest room”. In this way, an absence time or a default absence state is added to status information of a user to update the status information stored in the status information table 205. Then, the other users receive generated latest status information. Thus, the other users can estimate when the user will be back to the user's office. In addition, a user can reduce time and labor for manually changing schedule information every time the user is out due to a slight business.

In addition, for example, if present and last schedules do not exist in schedule information of a user, the status information updating means 204 transfers a schedule information operating command for assuming the next schedule in the schedule information of the user as the present schedule to the schedule information managing means 202. Then, the schedule information managing means 202 having received the schedule information operating command from the status information updating means 204 writes the next schedule in the schedule information stored in the schedule information storing means 201. In addition, the status information updating means 204 converts the schedule information in which the next schedule is written to status information, and updates the status information stored in the status information table 205 using this converted status information. Further, it is also possible to set the schedule information managing means 202 not to automatically write a schedule in schedule information.

Then, the status information updating means 204 sends a sending command including the updated status information and a destination or the like to the status information sending means 208 in order to send the updated status information to the user terminal devices 102 to 105.

In addition, if a schedule information operating command is included in a received status information signal as a status information operating command, the status information updating means 204 transfers the received schedule information operating command to the schedule information managing means 202.

Here, reasons why the status information updating means 204 is set to operate in accordance with the presence or absence of present and last schedules in schedule information and a presence status in received status information are as described below.

For example, if there is no present schedule and a last schedule is “attend a meeting” or “out” in schedule information of a user saved in the schedule information storing means 201, it is possible that a user is actually absent because the meeting or the outside work of the last schedule is extended, regardless of the fact that there is no present schedule. In addition, if a user is absent due to a meeting, an outside work or the like, it is possible that the user cannot change (extend) schedule information because the user is away from the user's terminal among the user terminals 102 to 105.

The status information table 205 will now be described. The status information table 205 is a table in which data related to a present status of a user such as a name, a presence status, a work status, an address, a location, a contact, availability of contact, a status of input in an input device, a name of an operating application, images, voices and the like of each user is recorded. The status information table 205 is used for sending stored status information to the status information displaying means 207 to display the status information, and for sending stored status information to the status information sending means 208 together with a sending command including a destination in order to distribute the status information of each user of the user terminal devices 102 to 105. Thus, information stored in the status information table 205 can be appropriately updated by the status information updating means 204.

The status information input means 206 inputs a command for operating status information stored in the status information table 205 and schedule information stored in the schedule information storing means 201, and a command for operating a server as well as status information of a user. In addition, the status information input means 206 sends these command and the status information to the status information generating means 203.

The status information displaying means 207 displays status information of users stored in the status information table 205. A use may be able to set to display/not to display the status information of users to be displayed on this status information displaying means 207 for each user or group, and status information concerning a user not to be displayed may not be communicated with a server device. In this case, it is possible to display only information required by a user, and it is also possible to reduce communication with the server device. Further, although it is described that status information is displayed by the status information displaying means 207, the present invention is not limited to this, and status information may be printed out from a printing device such as a printer connected to each of the user terminal devices 102 to 105, or may be outputted as voices from a device such as a speaker connected to each of the user terminal devices 102 to 105 other than being displayed by the status information displaying means 207. In this case, the status information can be confirmed in various forms (a print of a screen display, a voice message).

The status information sending means 208 sends status information to designated one(s) of the user terminal devices 102 to 105 in accordance with a sending command received from the status information updating means 204 or the status information table 205.

The status information receiving means 209 receives a status information signal sent from each of the user terminal devices 102 to 105. In addition, the status information receiving means 209 sends the received status information signal to the status information updating means 204.

The client X installed in each of the user terminal devices 102 to 105 will be hereinafter described.

The client X is provided with an interface for displaying status information, displays latest status information of a user operating the client X and the other users and, at the same time, updates status information according to a change of status information of each user.

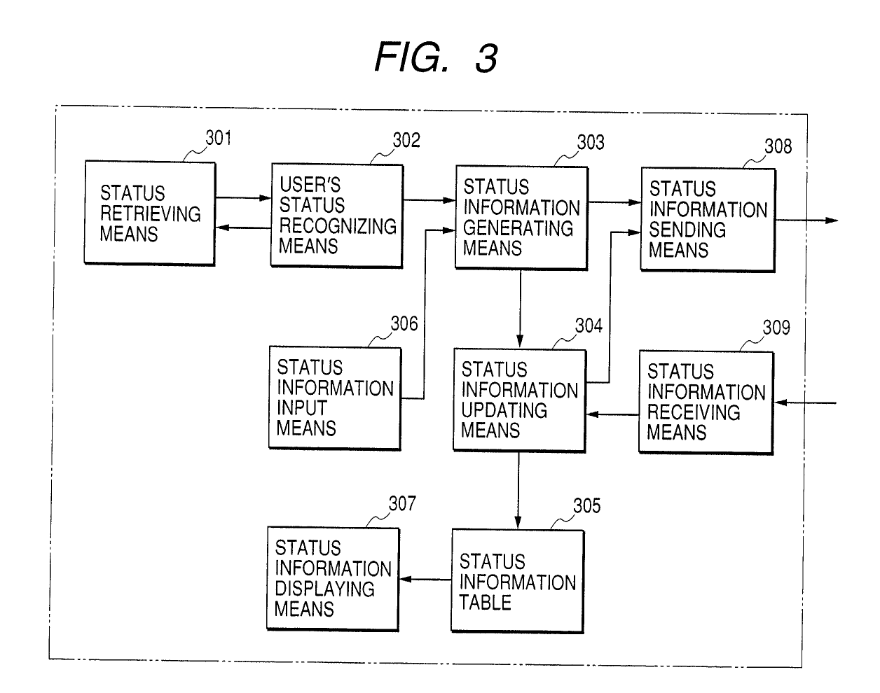

A functional configuration of the client X will be hereinafter described with reference to a block diagram of FIG. 3. The client X is provided with a status retrieving means 301, a user's status recognizing means 302, a status information generating means 303, a status information updating means 304, a status information table 305, a status information input means 306, a status information displaying means 307, the status information sending means 308 and the status information receiving means 309.

The status retrieving means 301 retrieves a status of a user operating the client X. The status retrieving means 301 is composed of a camera for photographing a status of a user, an application in use checking tool for checking applications used on the user terminal devices 102 to 105 by users, and an input status checking tool for checking input statuses in the user terminal devices 102 to 105 by keyboards, pointing devices or the like of the users. In addition, the status retrieving means 301 transfers images or each check result retrieved by these tools to the user's status recognizing means 302.

The user's status recognizing means 302 recognizes a presence status, a work status, an input status or the like of a user based on various statuses (images, each check results or the like) concerning the user received from the status retrieving means 301. In addition, the user's status recognizing means 302 activates the status retrieving means 301 and causes the status retrieving means 301 to retrieve various statuses concerning the user periodically or according to an instruction of the status information generating means 303. In addition, the user's status recognizing means 302 sends recognized status information to the status information generating means 303.

For example, if the user's status recognizing means 302 receives an image or a moving image of a user photographed by a camera from the status retrieving means 301, it determines whether or not the user is seated around the user's terminal device among the user terminal devices 102 to 105 by image recognition, and recognizes a presence status. In addition, if the user's status recognizing means 302 receives a check result from the application in use checking tool or the input status checking tool, it recognizes status information such as a work status, such as busyness, and a presence status of a user from the check result.

The status information generating means 303 generates a status information operating command composed of status information inputted from the status information input means 306, a command for operating the status information, a command for operating a server or the like, and a status information signal composed of status information of a user inputted from the status information input means 306 and status information of a user received from the user's status recognizing means 302. In addition, the status information generating means 303 sends the generated status information signal to the status information sending means 308 in order to send it to the server S. Then, if a change is found in status information included in the generated status information signal, the status information generating means 303 sends the generated status information signal to the status information updating means 304 in order to update the status information.

The status information updating means 304 conducts processing based on the status information signal received from the status information generating means 303 or the status information receiving means 309. For example, if a status information update command is included in the received status information signal as a status information operating command, the status information updating means 304 updates the status information stored in the status information table 305 based on status information included in the received status information signal.

The status information table 305 is a table in which data related to a status information of a user such as a name, a presence status, a work status, a status of input in an input device, a name of an operating application, availability of contact, an address, a location, a contact, images, voices and the like of each user is recorded. The status information table 305 is synchronized such that it has the same contents as the status information table 205 on the server S. In addition, the status information stored in the status information table 305 is sent to the status information displaying means 307 in order to display status information. In addition, the status information stored in the status information table 305 can be updated properly by the status information updating means 304.

The status information input means 306 inputs a command for operating the status information stored in the status information table 305 or the schedule information stored in the schedule information storing means 201 of the server S, a command for operating a server, and status information of a user. In addition, the status information input means 306 sends the inputted command or status information to the status information generating means 303.

The status information displaying means 307 displays the status information stored in the status information table 305.

The status information sending mens 308 sends the status information signal received form the status information generating means 303 or the status information updating means 304 to the server S.

The status information receiving means 309 receives status information from the server S. In addition, the status information receiving means 309 sends the received status information to the status information updating means 304 and updates the status information stored in the status information table 305.

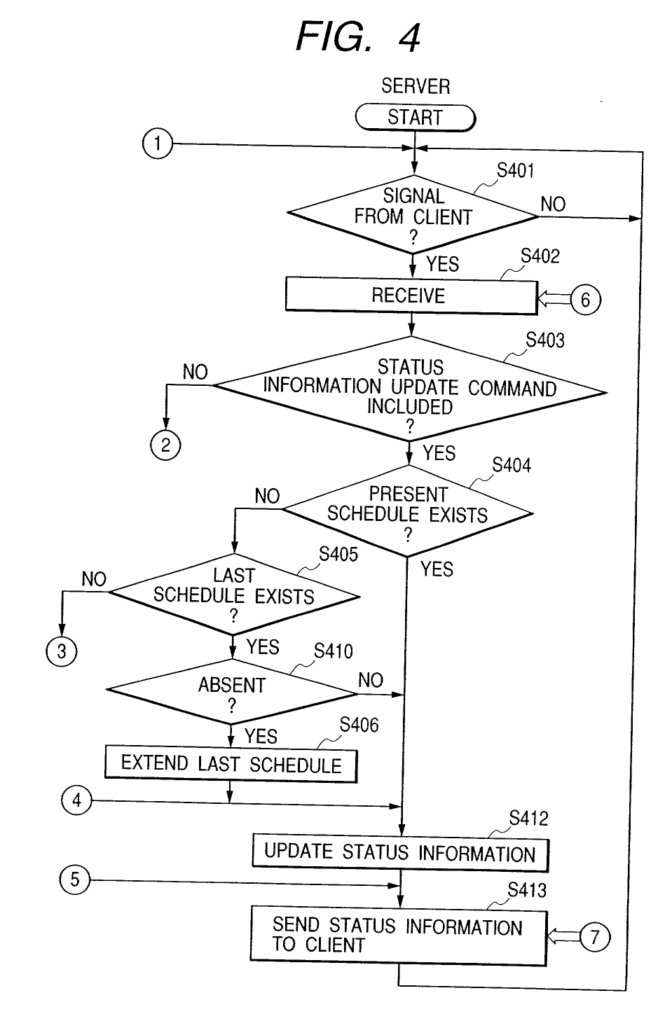

Operations and processing of a status information sharing function performed by the server S and the client X in the status information sharing system of this embodiment will be described with reference to a flow chart of FIGS. 4 to 6. Further, the client X will be hereinafter described as installed in the user terminal device 102 among the user terminal devices 102 to 105.

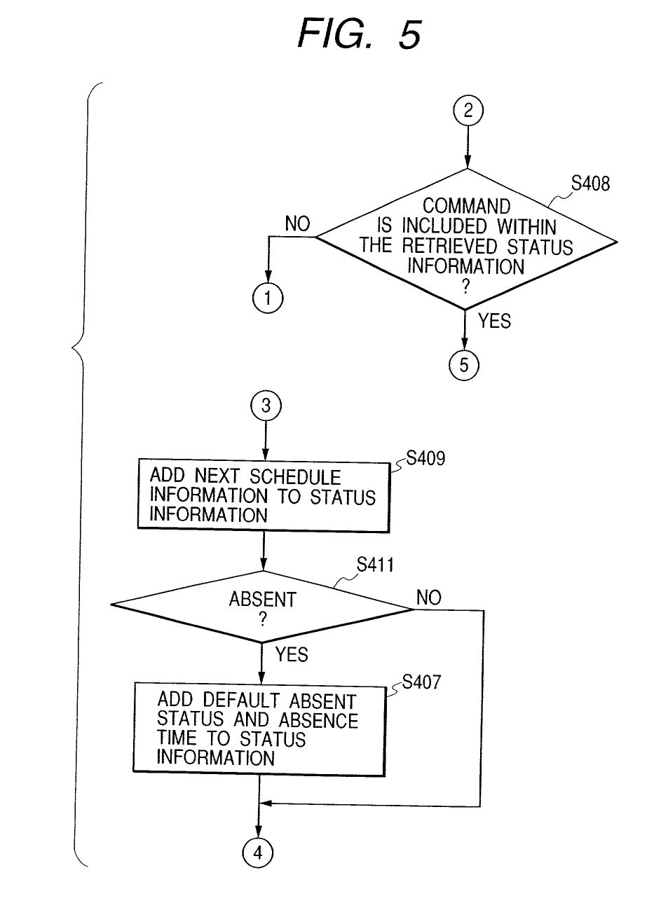

First, operations of the server S will be described with reference to the flow chart of FIGS. 4 to 5.

In step S401, the server S determines whether or not a status information signal has been sent from the client X.

If it is determined in step S401 that the status information signal has been sent, the status information receiving means 209 receives the status information signal in step S402.

In step S403, the status information updating means 204 determines whether or not a status information update command is included in the status information signal received in step S401 as a status information operating command.

If it is determined in step S403 that the status information update command is included, the status information updating means inquires the schedule information managing means 202 whether or not a present schedule exists in schedule information of a user who handles the client X in step S404.

If it is determined in step S404 that a present schedule exists, the status information updating means 204 updates the status information stored in the status information table 205 in step S412 based on status information included in the status information signal received in step S401.

In addition, if it is determined in step S404 that a present schedule does not exist, the status information updating means 204 determines whether or not a last schedule exists in the schedule information of the user in step S405.

If it is determined in step S405 that a last schedule exists, the status information updating means 204 determines in step S410 whether or not a presence status of the user included in the status information signal received in step S402 is absent.

If the presence status of the user is absent in step S410, it is possible that the last schedule is prolonged. Therefore, the status information updating means 204 transfers a schedule information operating command for automatically extending a last schedule of a user to the schedule information managing means 202 in step S406.

Then, the schedule information managing means 202 having received the schedule information operating command from the status information updating means 204 writes the extended schedule in the schedule information stored in the schedule information storing means 201. Further, it is also possible to set the schedule information managing means 202 not to automatically write a schedule in the schedule information.

In step S412, the status information updating means 204 converts the schedule information in which the extended schedule is written to status information, and updates the status information stored in the status information table 205 with this converted status information.

In addition, if it is determined in step S405 that a last schedule does not exist, the status information updating means 204 adds a next schedule in the schedule information of the user in the status information in step S409 (FIG. 5).

The status information updating means 204 determines in step S411 whether or not a presence status of the user included in the status information signal received in step S402 is absent.

If it is determined in step S411, the status information updating means 204 counts absent time during which the user is continuously absent from the office, and adds this absent time to the status information. In addition, if a default absence state (rest, smoking, rest room or the like) is set by the user in advance, the status information updating means 204 adds the default absent state to the status information. Further, it is also possible to combine a counted absence time and a default absence state to have status information of “smoking: absent for 5 minutes”.

In step S412, the status information updating means 204 updates the status information stored in the status information table 205 based on the status information to which new information is added in step S409 or step S407.

In step S413, the status information sending means 208 sends the latest status information updated by the status information updating means 204 in step S412 to the clients 1 to N of each user terminal device.

In addition, if it is determined in step S403 that a status information update command is not included in the status information signal, the status information updating means 204 determines in step S408 whether or not a status information retrieving command is included in the status information signal as a status information operating command.

If it is determined in step S408 that the status information retrieving command is included the status information signal , the status information sending means 208 sends latest status information stored in the status information table 205 to the clients 1 to N of designated one(s) of the user terminal devices 102 to 105 in step S413 in accordance with the status information retrieving command.

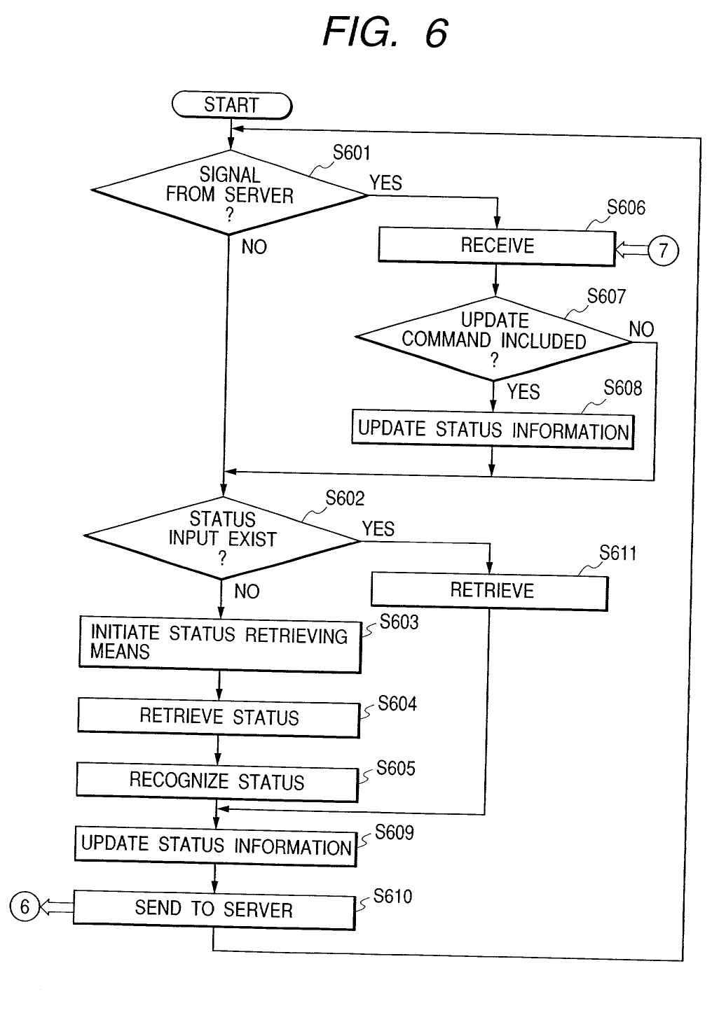

Operations of the clients 1 to N installed in the user terminal devices 102 to 105 will now be described with reference to a flow chart of FIG. 6.

In step S601, the client server X determines whether or not a status information signal has been sent from the server S.

If it is determined in step S601 that the status information signal has been sent, the status information receiving means 309 receives the status information signal in step S606.

In step S607, the status information updating means 304 determines whether or not a status information update command is included in the status information signal received in step S601 as a status information operating command.

If it is determined in step S607 that the status information update command is included in the status information signal, the status information updating means 304 updates the status information stored in the status information table 305 based on the status information included in the status information signal received in step S601.

If it is determined in step S601 that a status information signal has not been sent, the client X determines in step S602 whether or not status information and a status information operating command are inputted by the status information input means 306.

If it is determined in step S602 that status information and a status information operating command are inputted, the status information generating means 303 reads the inputted status information operating command and status information and generates a status information signal composed of the read status information operating command and status information in step S611.

If it is determined in step S602 that status information and a status information operating command are not inputted, the status information generating means 303 activates the status retrieving means 301 in order to retrieve status information of the user in step S603. Further, the status retrieving means 301 may be activated periodically or after predetermined time elapses. (Steps S603, S301, S302, S303 and S306). In step S604, the status retrieving means 301 activated by the status information generating means 303 photographs a user by a camera to obtain images, checks an application that a user uses by an application in use checking tool, or checks input status of a keyboard, a pointing device or the like of a user by an input status checking tool. Then, the status retrieving means 301 transfers information concerning the images or check results to the user's status recognizing means 302.

In step S605, the user's status recognizing means 302 recognizes status information such as a presence status, a work status and an input status based on the images and the check results received from the status retrieving means 301 in step S604.

For example, if the user's status recognizing means 302 receives a still image or a moving image in which a state of a user is photographed from the status retrieving means 301, it determines whether or not the user is seated around the user terminal device X by image recognition, and recognizes status information of a presence status and a work status such as busyness. In addition, if the user's status recognizing means 302 receives the check results of the input status checking tool, it recognizes a status of input indicated by the results, and also recognizes status information such as a presence status and a work status indicating busyness or the like according to the input status. In addition, if the user's status recognizing means 302 receives check results of the application in use checking tool from the status retrieving means 301, it recognizes status information such as a work status of the user and a work status indicating busyness or the like according to an application in use name included in the check results.

Then, the user's status recognizing means 302 sends the recognized information to the status information generating means 303. The status information generating means 303 generates a status information signal composed of a status information operating command and the status information received from the user's status recognizing means 302.

In step S609, the status information updating means 304 updates the status information stored in the status information table 305 based on status information included in the status information signal generated in step S605.

In step S610, the status information sending means 308 sends the status information of the user of the client X updated in step S609 to the server S.

With the above-mentioned operations, status information stored in the status information table 305 of the client X is sequentially updated such that the status information coincides with status information stored in the status information table 205 of the server S, and latest status information of each user is displayed on a display of the user terminal device X in which the client X is installed.

As described above, when status information of a user such as a work status and a presence status is provided to the other users, the status information sharing system of this embodiment generates latest status information based on schedule information and status information of the user and provides the latest status information to the other users.

Thus, there is an effect that more accurate status information can be provided to the other users compared with the case in which the latest status information is generated based on either the schedule information or the status information of the user.

Further, the status information sharing system of this embodiment generates latest status information based on default status information set by a user in advance in addition to schedule information and status information of the user. Thus, there is an effect that time and labor of the user for manually changing schedule information can be eliminated.

In addition, although a user's status recognizing means for recognizing a presence status or the like of a user is held by a user terminal device and a schedule information storing means for storing a schedule of each user is held by a server device in this embodiment, the present invention is not limited to this. A user's status recognizing means for recognizing a presence status or the like of a user may be held by a server device, which recognizes the status information of the user from various statuses sent from the user. In this case, there is an effect that processing of a user terminal device can be reduced.

Second Embodiment

A status information sharing system of this embodiment notifies each user terminal device of latest status information based on, in particular, a presence status of a user. Operations different from those of the above-mentioned first embodiment will be hereinafter described in this embodiment.

In this embodiment, if a present schedule exists in a schedule information of a user and a presence status included in a status information signal of the user indicates absence, the user is presently absent as shown in the schedule of the schedule information, thus the status information updating means 204 of the server S shown in FIG. 2 updates status information stored in the status information table 205 with the present schedule in the schedule information of the user as status information.

On the other hand, if a presence status of a user indicates “seated” regardless of the fact that a present schedule exists in schedule information of the user, it is possible that the present schedule of the schedule information has been changed. Thus, the status information updating means 204 instructs the status information sending means 208 to send a status information signal including a schedule information change confirming command to the user terminal device 102 of the user as a status information operating command in order to confirm with the user if schedule information stored in the schedule information storing means 201 should be changed. If the user confirms that the schedule information should be changed, the status information updating means 204 transfers a schedule information operating command for changing a schedule of a user to the schedule information managing means 202. Then, the schedule information managing means 202 having received the schedule information operating command from the status information updating means 204 writes the changed schedule in the schedule information stored in the schedule information storing means 201. Further, it is also possible to set the status information updating means 204 in advance to automatically change schedule information without confirming with a user. Then, the status information updating means 204 converts the schedule information in which the changed schedule is written to status information, and updates the status information stored in the status information table 205 with this converted status information. In addition, the status information updating means 204 sends a sending command including the updated status information and information such as a destination to the status information sending means 208 in order to instruct the status information sending means 208 to send the updated status information to the user terminal devices 102 to 105.

In addition, if a schedule information retrieving command is included in the received status information signal as a status information operating command, the status information updating means 204 instructs the status information sending means 208 to send latest status information stored in the status information table 205 to the user terminal devices 102 to 105 in accordance with the schedule information retrieving command.

In addition, if a schedule information operating command is included in the received status information signal as a status information operating command, the status information updating means 204 transfers the schedule information operating command to the schedule information managing means 202.

Here, the reason why the status information updating means 204 is set to operate based on whether or not there is a present schedule in schedule information and a presence status included in a received status information signal is as described below.

For example, while there is a schedule such as “attend a meeting” or “out the door” as a present schedule in schedule information of a user saved in the schedule information storing means 201, it is possible that the user does not actually attend a meeting or is not out as indicated in the schedule of the schedule information. In addition, if a schedule has been changed, it is also possible that a user forgets to change a schedule in schedule information.

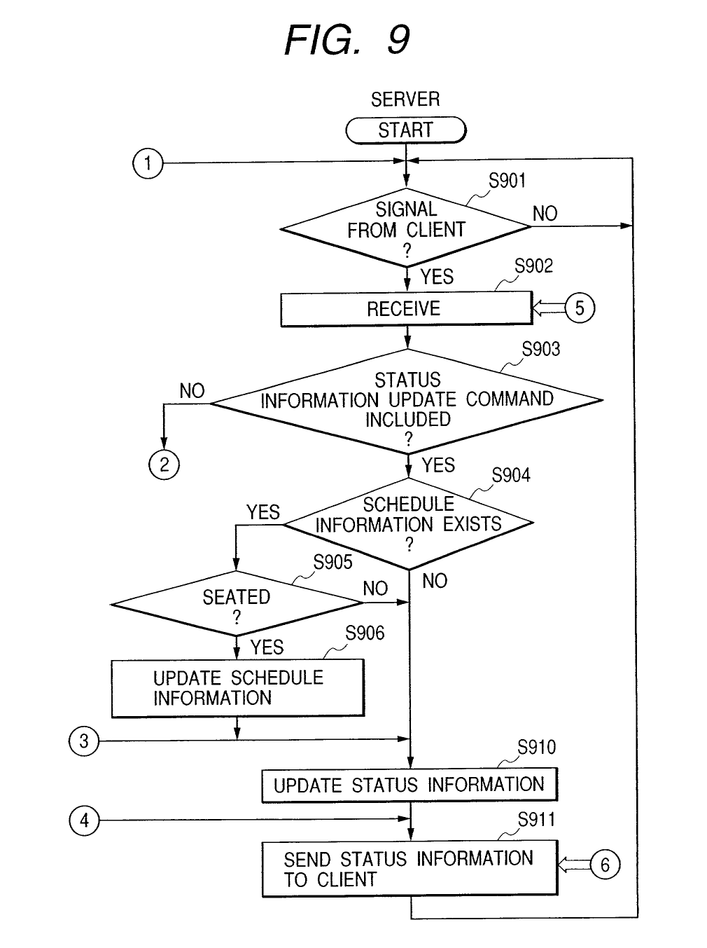

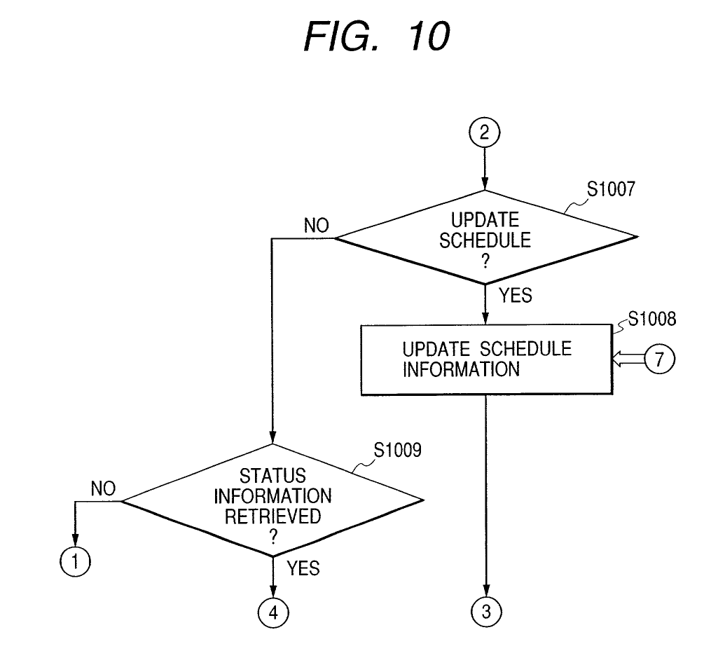

Operations of the server S in this embodiment will now be described with reference to a flow chart of FIGS. 9 and 10.

In step S901, the server S determines whether or not a status information signal has been sent from the client X.

If it is determined in step S901 that the status information signal has been sent, the status information receiving means 209 receives the status information signal in step S902.

In step S903, the status information updating means 204 determines whether or not a status information update command is included in the received status information signal as a status information operating command.

If it is determined in step S903 that a status information update command is included in the received status information signal, the status information updating means 204 inquires the schedule information managing means 202, and determines a present schedule exists in schedule information of a user who handles the client X stored in the schedule information storing means 201 in step S904.

If it is determined in step S904 that a present schedule does not exist, the status information updating means 204 updates status information stored in the status information table 205 based on the status information included in the received status information signal.

In addition, if it is determined in step S904 that a present schedule exists, the status information updating means 204 determines in step S905 whether or not the user is seated from a presence status included in the received status information signal.

If the presence status indicates absence of the user in step S905, the status information updating means 204 converts the schedule information including the present schedule of the user to status information, and updates the status information stored in the status information table 205 with the converted status information in step S910.

In addition, if the presence status indicates in step S905 that the user is seated, the status information updating means 204 instructs the schedule information managing means 202 to change or delete the present schedule in the schedule information of the user in step S906.

Further, the status information updating means 204 may confirm with the user that the present schedule in the schedule information should be changed and, then, change the schedule information. Operations in this case will be described with reference to the flow chart of FIG. 10. First, in step S1007, the status information updating means 204 sends status information including a schedule information change confirming command as a status information operating command to the user's terminal device among the user terminal devices 102 to 105, and determines whether or not the user has confirmed the change of the schedule information.

If it is determined in step S1007 that a change has been confirmed, the status information updating means 204 instructs the schedule information managing means 202 to change or delete the present schedule in the schedule information of the user. The schedule information managing means 202 having received the instruction changes the present schedule in the schedule information of the user stored in the schedule information storing means 201.

In addition, if it is determined in step S1007 that a change has not been confirmed, the status information retrieving means 204 determines whether or not a status information retrieving command is included in the received status information signal as a status information operating command in step S1009. If it is determined in step S1009 that the status information retrieving command is included in the received status information signal, the processing of step S911 is performed.

In step S911, the status information sending means 208 sends latest status information stored in the status information table 205 to the user terminal devices 102 to 105 according to an instruction of the status information updating means 204.

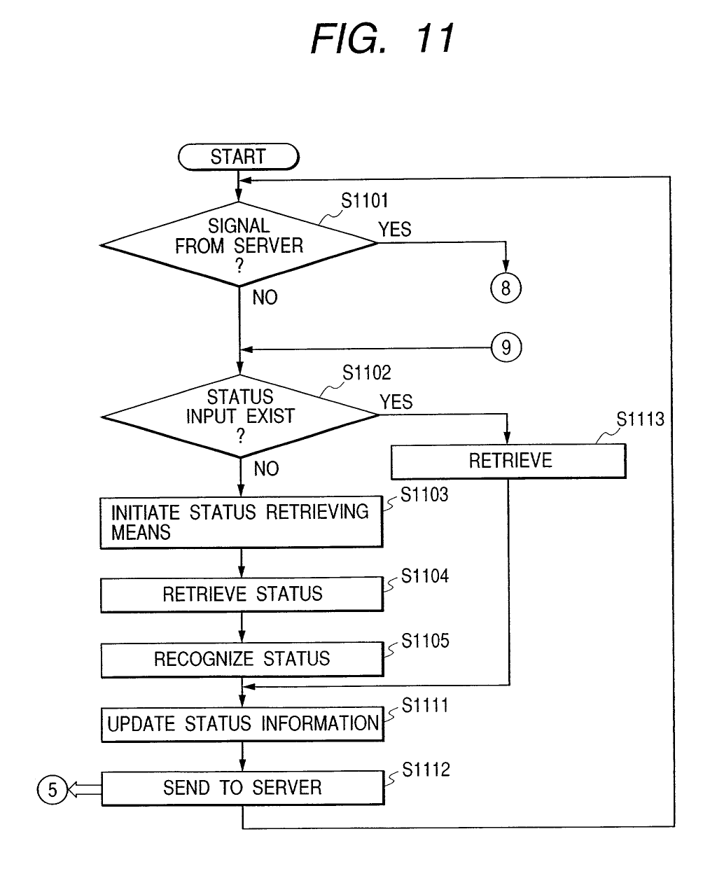

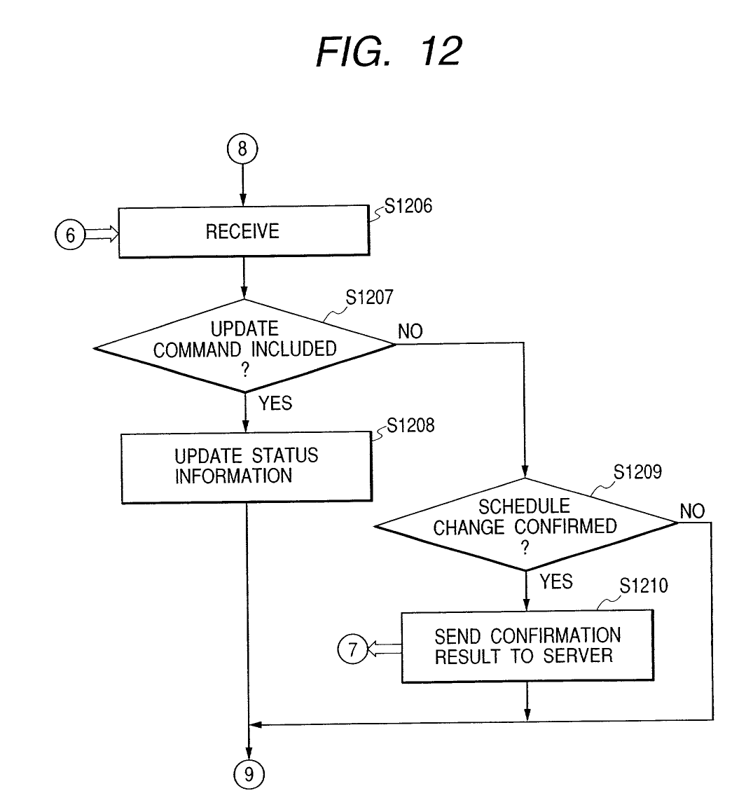

Operations of the client X in this embodiment will now be described with reference to a flow chart of FIGS. 11 and 12.

In step S1101, the client X determines whether or not a status information signal has been sent from the server S.

If it is determined in step S1101 that status information signal has been sent from the server S, the status information receiving means 309 receives the status information signal in step S1206.

In step S1207, the status information updating means 304 determines whether or not a status information update command is included in the status information signal received from the server S as a status information operating command.

If it is determined in step S1207 that a status information update command is included in the status information signal, the status information updating means 304 updates status information stored in the status information table 305 based on status information included in the status information signal received from the status information receiving means 309.

In addition, if it is determined in step S1207 that a status information update command is not included in the status information signal, the status information updating means 304 determines whether or not a schedule information change confirming command is included in the status information signal received from the server S as a status information operating command.

If it is determined in step S1209 that a schedule information change confirming command is included in the status information signal , the client X confirms with the user whether or not schedule information should be changed, and sends the confirmation results to the server S in step S1210. As described above, the client X processes a status information signal from the server S.

In step S1102, the client X determines whether or not the user has inputted status information by the status information inputting means 306.

If it is determined in step S1102 that status information has been inputted, the status information generating means 303 reads the inputted user's status information and a status information operating command and generates a status information signal composed of the user's status information and the status information operating command.

If it is determined in step S1102 that status information has not been inputted, the status information generating means 303 periodically activates the status retrieving means 301 in order to retrieve status information of the user in step S1103. In this way, the status retrieving means 301 photographs an image or a moving image of the user by a camera, or checks a use status of an application of the user by an application in use checking tool or an input status checking tool.

In step S1104, the status retrieving means 301 transfers a work status in the user's terminal device among the user terminal devices 102 to 105 and a status of input in an input device such as a keyboard or the like of the user, which have been retrieved from the camera, the application in use checking tool and the input status checking tool, to the user's status recognizing means 302.

In step S1105, the user status recognizing means 302 recognizes status information including a presence status of the user based on the work status and the input status of the user received from the status retrieving means 301. For example, if the user status recognizing means 302 receives an image or a moving image of the user photographed by a camera from the status retrieving means 301, it determines whether or not the user is seated around the user's terminal device among the user terminal devices 102 to 105 and recognizes a presence status. In addition, if the user's status recognizing means 302 receives check results from the application in use checking tool and the input status checking tool, it recognizes status information such as a work status, such as busyness, and a presence status of the user from the check results such as an application in use name. Then, the status information generating means 303 generates a status information signal composed of a status information operating command and the status information of the user based on the recognized status information.

In step S1111, the status information updating means 304 updates the status information stored in the status information table 305 based on the status information included in the status information signal generated in step S1105.

In step S1112, the status information sending means 308 sends the latest status information stored in the status information table 305 of the client X.

With the operations described above, status information held by the server S and status information held by each client X are sequentially updated to coincide with each other. In addition, status information of each user indicated on the display of each of the user terminal devices 102 to 105 in which the client X is installed is also sequentially updated to latest status information.

Third Embodiment

This embodiment has an effect that a status information sharing system can be realized which can reduce loads on the server device 701 by separately providing a device as a schedule information storing device for storing schedule information.

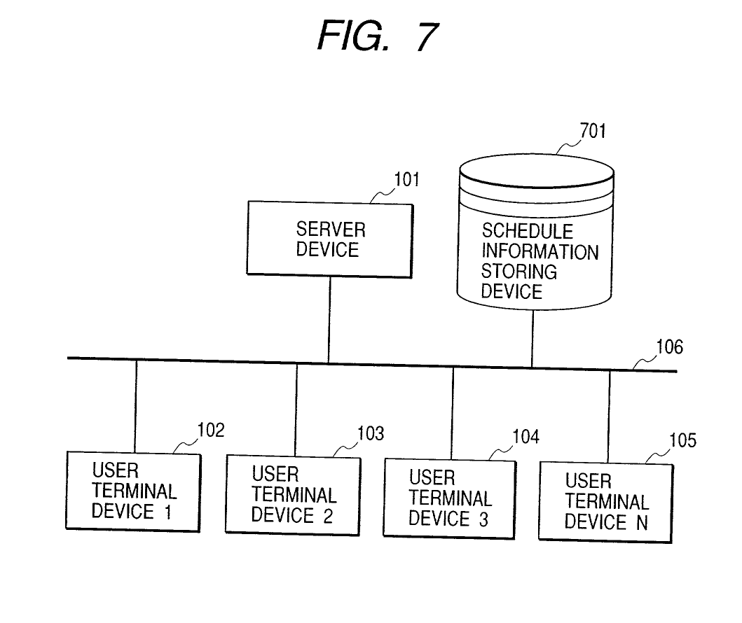

FIG. 7 is a block diagram showing an example of a configuration of a status information sharing system in accordance with this embodiment.

As shown in FIG. 7, the status information sharing system in accordance with this embodiment is provided with a schedule information storing device 701 separately from the server device 101 as opposed to the configuration shown in FIG. 1. The schedule information storing device 701 is a workstation or a personal computer and the like provided with a communication function, connected to the communication network 106 and can communicate with other schedule information storing devices. Further, the status information sharing system shown in FIG. 7 may be configured with the server device 101, the user terminal devices 102 to 105 and the schedule information storing device 701 arranged in a same office, or it may be configured with the server device 101, the user terminal devices 102 to 105 and the schedule information storing device 701 arranged in geographically separated places.

A server process (hereinafter referred to as the server) S for sharing status information among users is installed in the server device 101. Each of the user terminal devices 102 to 105 includes user's status recognizing means for recognizing a presence status or the like of a user and a client process (hereinafter referred to as the client) for sharing status information of each user. Schedule information of each user who handles each of the user terminal devices 102 to 105 is stored in the schedule information storing device 701.

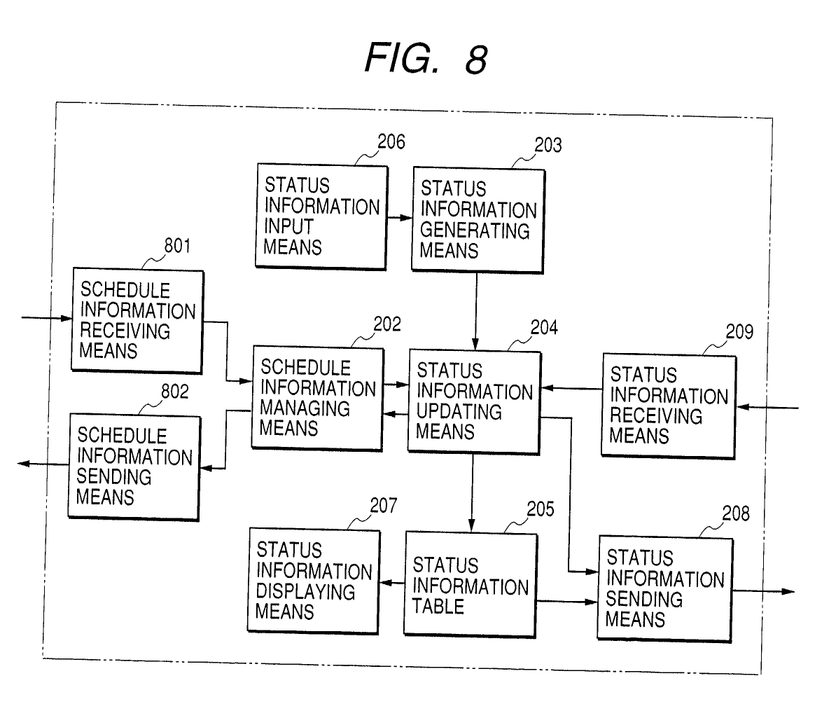

Functional operations of the server S of the status information sharing system in accordance with this embodiment will be described with reference to a block diagram of FIG. 8.

The server S in accordance with this embodiment collectively manages a group consisting of all users or a part of users connected to a network, and transmits latest status information to the client. Further, the server S is provided with a schedule information receiving means 801 and a schedule information sending means 802 in addition to the configuration shown in FIG. 3.

The schedule information managing means 202 operates and manages the schedule information storing device 701 on the network. The schedule information managing means 202 also controls the schedule information receiving means 801 and the schedule information sending means 802 to write schedule information of a user in the schedule information storing device 701 based on status information received from the status information updating means 204 together with a request, delete schedule information, and read schedule information of a user from the schedule information storing device 701 to convert it to status information.

The schedule information receiving means 801 receives schedule information from the schedule information storing device 701. In addition, the schedule information receiving means 801 also sends the received schedule information to the schedule information managing means 202.

The schedule information sending means 802 sends a schedule information operating command to the schedule information storing device 701.

According to the status information sharing system of this embodiment described above, there is an effect that loads to a server device can be reduced by providing a schedule information storing device for storing schedule information separately from the server device.

Fourth Embodiment

A status information sharing system of this embodiment notifies each user terminal device of latest status information based on, in particular, a presence status of a user.

Further, it is assumed that each user has completed connection to the server device 101 using each of the user terminal devices 102 to 105, and has started work.

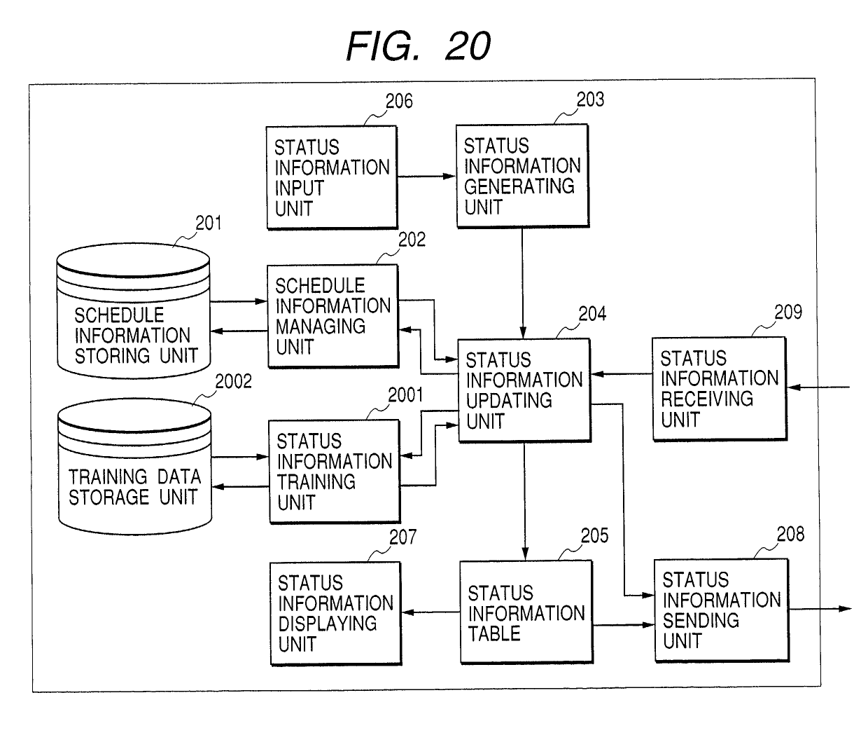

FIG. 20 is a block diagram showing a functional configuration of the server S. The server S collectively manages schedule information of a group consisting of all users or a part of users connected to the network 106, converts the schedule information to status information, and sends latest status information of each of the user terminal devices 102 to 105 to the other user terminal devices 102 to 105.

As shown in FIG. 20, the server S is composed of a status information training unit 2001 and a training data storage unit 2002 in addition to the means shown in FIG. 2.

The status information training unit 2001 operates and manages the training data storage unit 2002 to be described later. The status information training unit 2001 writes training data to be described later in the training data storage unit 2002 and deletes training data based on received status information in accordance with a request from the status information updating unit 204. Alternatively, the status information training unit 2001 reads training data of a user from the training data storage unit 2002, estimates a present status of the user and converts it to status information. For example, if a behavior pattern of a user “attend a meeting from 10:00 to 11:00 every Tuesday” is shown in training data, the status information training unit 2001 estimates a present status as “attend a meeting from 10:00 to 11:00 today (Tuesday)”, and converts the present status to status information. In addition, if the status information or the schedule information received from the status information updating unit 204 does not exist in the training data stored in the training data storage unit 2002, the status information training unit 2001 registers the status information or the schedule information in the training data storage unit 2002 as training data for estimating status information.

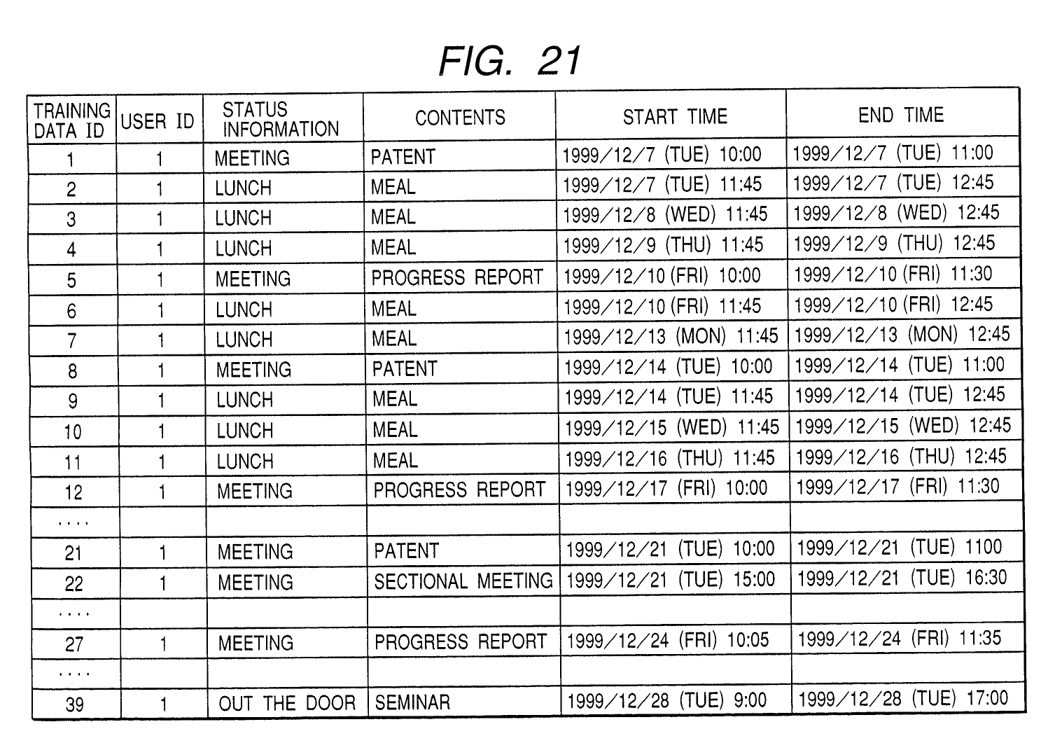

The training data storage unit 2002 stores training data consisting of past schedules of a user, and writes or reads the training data of the user in accordance with a request from the status information training unit 2001. Further, training data is stored in the training data storage unit 2002 as a table shown in FIG. 21.

The status information updating means 204 in this embodiment conducts processing based on a status information signal of a user received from the status information generating means 203, the status information receiving means 209 or the status information training means 2001. For example, if a status information update command is included in a received status information signal as a status information operating command, the status information updating means 204 updates the status information stored in the status information table 205 based on status information included in the received status information signal. At this point, the status information updating means 204 confirms with the schedule information managing means 202 whether a present schedule exists or not in schedule information of the user stored in the schedule information storage unit 201. Then, the status information updating means 204 applies processing to the schedule information managing means 202, the status information training means 2001 and the status information table 205 in accordance with the presence or absence of the present schedule and a presence status included in the received status information signal, and updates the status information. More specifically, if a present schedule does not exist in schedule information of a user and a presence status of the user is absent, the status information updating unit 204 transfers a training data operating command to the status information training unit 2001 in order to cause the status information training unit 2001 to automatically estimate present status information of the user.

The status information training unit 2001 having received the training data operating command estimates a behavior pattern of the user from the training data stored in the training data storage unit 2002. Further, if a plurality of behavior patterns are estimated from the past schedules of the user shown in the training data, the status information training unit 2001 can add an estimated plurality of pieces of status information and credibility of each piece of the state information to update the status information stored in the status information table 205. Therefore, the other users can estimate a status of the user, for example, when the user will be back. In addition, it is possible to reduce time and labor for manually changing a present schedule in the schedule information every time the user is out due to a slight business.

On the other hand, if training data does not exist in the training data storage unit 2002, the status information training unit 2001 registers present status information or schedule information in the training data storage unit 2002 as training data.

Then, the status information updating means 204 updates the status information stored in the status information table 205 with the status information estimated by the status information training unit 2001 as latest status information. Further, status information may be estimated according to setting. In addition, it is also possible not to automatically update status information.

In this way, by considering a behavior pattern estimated from training data indicating past schedules of a user, it is possible to provide the other users of more accurate status information of the user.

Further, the reason why the status information updating unit 204 is set to operate in accordance with the presence or absence of a present and a last schedules in schedule information and a presence status included in received status information signal is as described below. For example, if there is no present schedule in schedule information of a user but presence status of the user indicates absent, and training data indicating past schedules of the user such as “attend a meeting” or “out” at this time of every week is saved in the training data storing unit 2002, it can be estimated that the user “attends a meeting” or is “out” at present.

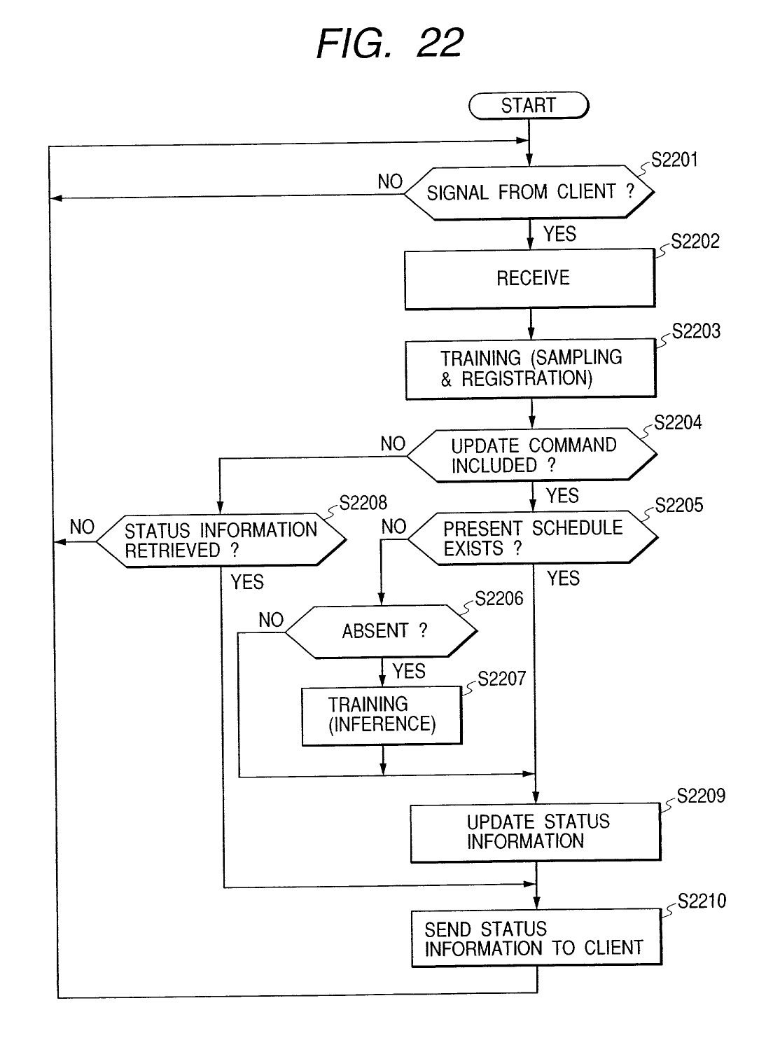

Procedures for processing status information sharing operations of the server S in this embodiment will now be described with reference to a flow chart of FIG. 22. Further, these processing programs are stored in storage media in the server device 101 and the user terminal devices 102 to 105, respectively, and are executed by each CPU.

First, in step S2201, the server S determines whether or not a status information signal has been sent from the client X.

If it is determined in step S2201 that a status information signal has been sent, the status information receiving unit 209 receives the status information signal in step S2202.

If status information included in the status information signal received in step S2202 or a schedule indicated by schedule information does not exist in the training data stored in the training data storage unit 2002, the status information training unit 2001 registers the status information or the schedule information in the training data storage unit 2002 to have training data for estimating a behavior pattern of a user in step S2203.

In step S2204, the status information updating means 204 determines whether or not a status information update command is included in the status information signal received in step S2202 as a status information operating command.

If it is determined in step S2204 that the status information update command is included in the status information signal, the status information updating means 204 inquires the schedule information managing unit 202 and determines whether or not a present schedule exists in schedule information of a user who handles the client X stored in the schedule information storage unit 201 in step S2205.

If it is determined in step S2205 that a present schedule exists in the schedule information, the status information updating means 204 updates the status information stored in the status information table 205 based on status information included in the received status information signal in step S2209.

If it is determined in step S2205 that a present schedule does not exist in the schedule information, the status information updating means 204 determines in step S2206 whether or not a presence status included in the status information signal of the user received in step S2202 indicates the absence of the user.

If it is determined in step S2206 that the presence status indicates the absence of the user, the status information updating means 204 transfers a training data operating command to the status information training unit 2001 in step S2207 in order to cause the status information training unit 2001 to automatically estimate present status information of the user from the past schedules of the user. Here, if there is a past schedule “attend a meeting from 10:00 to 11:00 every Tuesday” in the training data (see FIG. 21) stored in the training data storage unit 2202, the status information training unit 2001 estimates a present status as “attend a meeting from 10:00 to 11:00 today (Tuesday)”. In addition, the status information training unit 2001 estimates “writing a patent at present”, “searching a patent at present”, “programming for . . . project at present” or the like from a work status such as a name of an application presently used included in the status information signal received in step S2202 or a status of input in the user terminal devices 102 to 105 and the training data stored in the training data storage unit 2002. Further, status information can be estimated according to a setting.

Then, in step S2209, the status information updating means 204 updates the status information stored in the status information table 205 with the behavior pattern estimated by the status information training unit 2001 as status information. In addition, if a plurality of behavior patterns are estimated from the past schedules of the user, the status information training unit 2001 can add an estimated plurality of pieces of status information and credibility of each piece of the state information to update the status information stored in the status information table 205. FIG. 13 illustrates the status information table 205 in which the status information with the plurality of pieces of status information and credibility of each piece of the state information added is stored. Further, it is also possible to set the status information updating means not to automatically change status information in advance.

In step S2210, the status information sending means 208 sends the latest status information stored in the status information table 205 that was updated in step S2209 to each of the user terminal devices 102 to 105.

If it is determined in step S2204 that the status information update command is not included in the status information signal, the status information updating means 204 determines in step S2208 whether or not a status information retrieving command is included in the status information signal received in step S2202 as a status information operating command.

If it is determined in step S2208 that a status information retrieving command is not included in the status information signal, the processing returns to step S2201.

If it is determined in step S2208 that a status information retrieving command is included in the status information signal, the status information sending means 208 sends the latest status information stored in the status information table 205 to designated one(s) of the user terminal devices 102 to 105 in accordance with the status information retrieving command in step S2210.

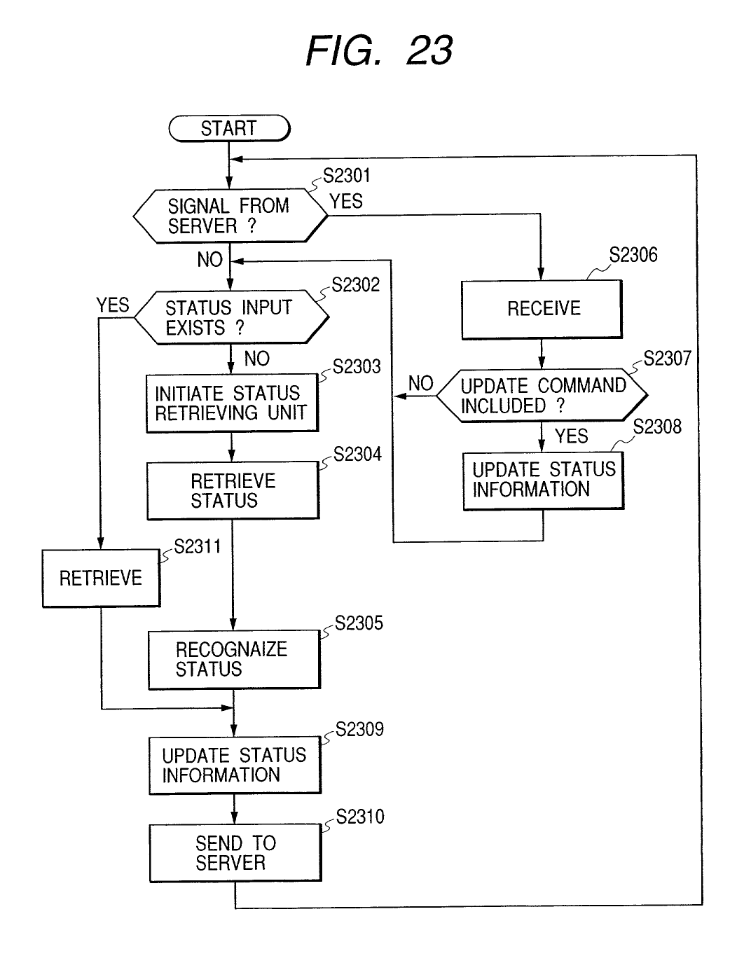

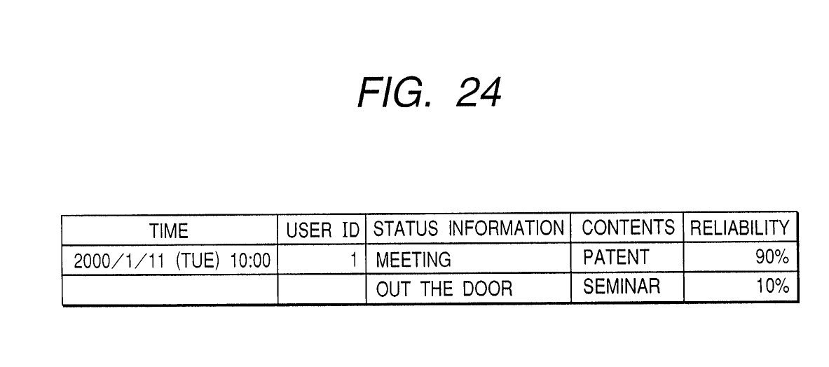

Procedures for processing status information sharing operations of the client X in this embodiment will now be described with reference to a flow chart of FIG. 23. Further, these processing programs are stored in storage media in the server device 101 and the user terminal device 102 to 105, respectively, and are executed by each CPU.

First, in step S2301, the client X determines in step S2301 whether or not a status information signal has been sent from the server S.

If it is determined in step S2301 that a status information signal has been sent from the server S, the status information receiving unit 309 receives the status information signal in step S2306.

In step S2307, the status information updating means 304 determines whether or not a status information update command is included in the status information signal received from the server S in step S2306 as a status information operating command.

If it is determined in step S2307 that a status information update command is included in the status information signal, the status information updating means 304 updates the status information stored in the status information table 305 based on status information included in the status information signal in step S2308.

If it is determined in step S2301 that a status information signal has not been sent from the server S, the client X determines whether or not the user has inputted status information in the status information input unit 806.

If it is determined in step S2302 that the status information has been inputted, the status information generating unit 303 reads the inputted status information operating command and status information of the user, and generates a status information signal composed of the status information operating command and status information of the user.

If it is determined in step S2302 that the user has not inputted status information in the status information input unit 306, the status information generating unit 303 periodically activates the status retrieving unit 301 in step S2303 in order to retrieve status information of the user.

In step S2304, the status retrieving unit 301 activated by the status information generating means 303 obtains images by photographing the user by a camera, checks an application used by the user by an application in use checking tool, or checks an input status of a keyboard, a pointing device or the like of the user by an input status checking tool. Then, the status retrieving unit 301 transfers information concerning the images or the check results to the user's status recognizing means 302.

In step S2305, the user's status recognizing means 302 recognizes status information of the user such as a presence status, a work status and an input status based on information concerning the images or the check results received from the status retrieving means 301 in step S2304.

For example, if the user's status recognizing means 302 receives a still image or a moving image in which a state of a user is photographed from the status 301, it determines whether or not the user is seated around the user terminal device X by image recognition, and recognizes status information of a presence status and a work status such as busyness. In addition, if the user's status recognizing means 302 receives the check results of the input status checking tool, it recognizes a status of input indicated by the results, and also recognizes status information such as a presence status and a work status indicating busyness or the like according to the input status. In addition, if the user's status recognizing means 302 receives check results of the application in use checking tool from the status retrieving means 301, it recognizes status information such as a work status of the user and a work status indicating busyness or the like according to an application in use name included in the check results. Then, the user's status recognizing means 302 sends the recognized status information to the status information generating means 303. The status information generating means 303 generates a status information signal composed of a status information operating command and the status information received from the user's status recognizing means 302.

In step S2309, the status information updating means 304 updates the status information stored in the status information table 305 based on status information included in the status information signal generated in step S2305.

In step S2310, the status information sending means 308 sends the latest status information updated in step S2309 to the server S.

In this way, status information stored in the status information table 805 of the client X is sequentially updated such that the status information coincides with status information stored in the status information table 705, and status information of each user on a display of a user terminal device in which the client X is installed is sequentially updated.

As described above, this embodiment estimates a present behavior pattern of a user from past schedules of the user. Thus, an accurate present status of a user can be provided to the other users. In addition, time and labor for manually changing a present schedule of schedule information can be reduced. In addition, if a plurality of behavior patterns are estimated, since credibility of each behavior pattern is also presented, the other users can estimate the status of the user according to the credibility, and can easily plan a schedule for communicating with the user.

Fifth Embodiment

In this embodiment, the training data storage means 2002 for storing training data is provided separately from the server device 101.

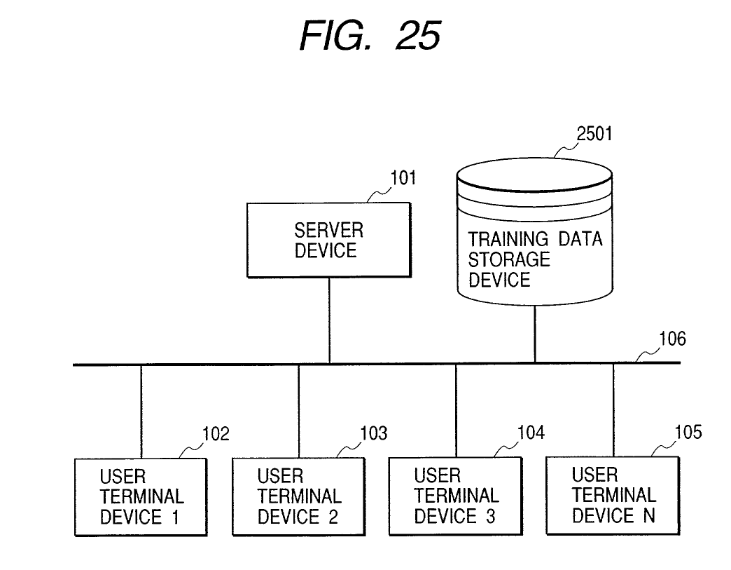

FIG. 25 illustrates a configuration of a status information sharing system in this embodiment. A training data storage device 2501 is a device provided with the training data storing means 2002 (see FIG. 20). Further, the status information sharing system in this embodiment may be configured with the server device 101, the user terminal devices 102 to 105 and the training data storage device 2501 arranged in a same office, or may be configured with the server device 101, the user terminal devices 102 to 105 and the training data storage device 2501 arranged in geographically separated places.

A server process (hereinafter, referred to as the server) for sharing status information among users is installed in the server device 101. Further, in this embodiment, a user status recognizing unit for recognizing a presence status or the like of a user is provided in each of the user terminal devices 102 to 105.

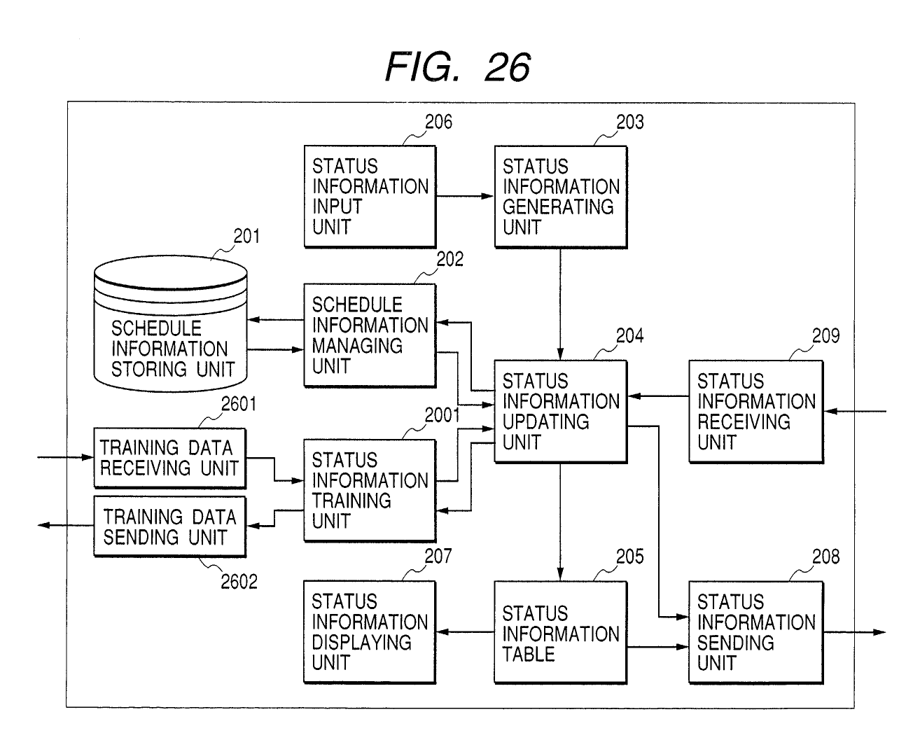

A functional configuration of the server S will be described with reference to a block diagram of FIG. 26. The server S in this embodiment is composed of a training data receiving unit 2601 and a training data sending unit 2602 in addition to the means shown in FIG. 20.

The status information training unit 2001 in this embodiment operates and manages the training data storage device 2501 on the network 106. The status information training unit 2001 writes training data of a user in the training data storage device 1302 based on the received status information and deletes training data therefrom in accordance with a request from the status information updating unit 204. In addition, the status information training unit 2001 reads training data of a user from the training data storage device 2501 and estimates a behavior pattern of this user. Then, the status information training unit 2001 controls the training data receiving unit 2601 and the training data sending unit 2602 in order to convert a behavior pattern to status information.

The training data receiving unit 2601 receives training data sent from the training data storage unit 2501 and sends the received training data to the status information training unit 2001.

The training data sending unit 2602 sends a training data operating command to the training data storage device 2501.

As described above, since a training data storage device is provides separately from a server device, loads on the server device can be reduced in this embodiment.

In addition, display/non display of status information of a user estimated by a status information training unit, which is displayed on a status information display unit, may be set for each user or each group by a user of the status information. Status information concerning a user that is not displayed may not be communicated with a server device. In this case, it is possible to display only information required by the user of the status information, and communication with the server device can be reduced.

Moreover, it is also possible to use a neural network as a method with which a status information training unit trains and estimates status information of a user.

Sixth Embodiment

The server S of this embodiment has a functional configuration as shown in FIG. 2. In addition, the client X has a functional configuration as shown in FIG. 3.

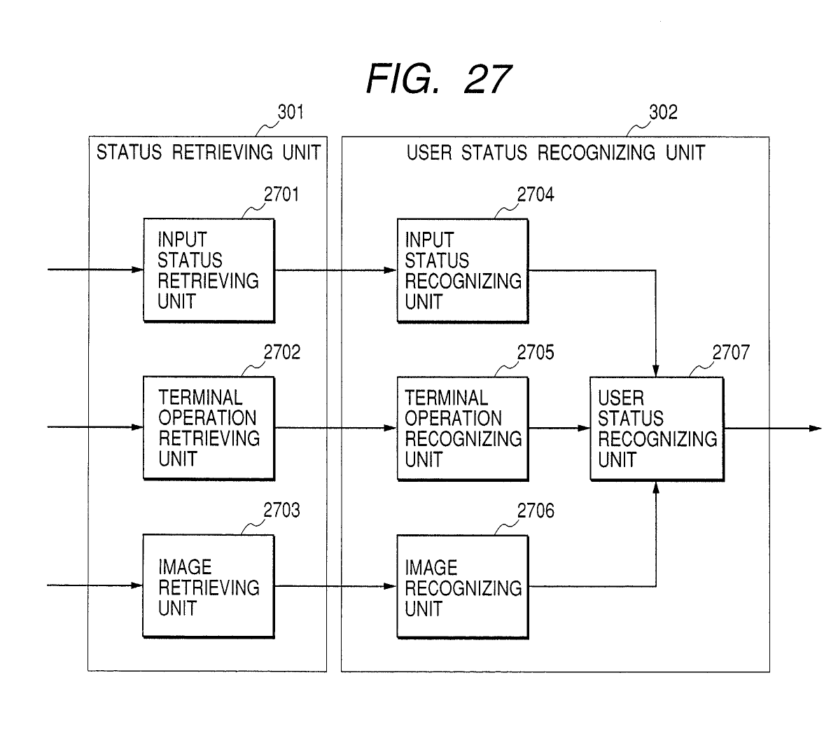

Configurations of the status retrieving unit 301 and the user status recognizing unit 302 in the client X of this embodiment will be described with reference to a block diagram of FIG. 27. The status information retrieving unit 301 includes input status retrieving means 2701, terminal operation retrieving means 2702 and image retrieving means 2703. The input status retrieving means 2701 retrieves a status of input in an input device such as a keyboard and a pointing device of a user. The terminal operation retrieving means 2702 checks an application in use or the like in order to retrieve a work status in each of the user terminal devices 102 to 105. The image retrieving means 2703 is a camera or the like for retrieving image data of a user. The status information retrieving unit 301 transfers the retrieved various states concerning a user such as an input status, a terminal operation and images to input status recognizing means 2704, terminal operation recognizing means 2705 and image recognizing means 2706 in the user status recognizing unit 302, respectively.

The user status recognizing means 302 activates the status retrieving unit 301 periodically or according to an instruction of the information generating means 303 in order to retrieve a status of a user. The user's status recognizing means 302 recognizes status information such as a presence status of a user from various status concerning the user received from the status retrieving unit 301. The recognized status information of the input status recognizing means 2704, the terminal operation recognizing means 2705, and the image recognizing means 2706 are sent to the user status recognizing means 2707.

For example, if the input status recognizing means 2704 receives a status of input in an input device such as a keyboard and a pointing device of a user from the input status retrieving means 2701, it recognizes status information such as a presence status and busyness of the user according to the input status. In addition, if the terminal operation recognizing means 2705 receives a name of an application used by a user or an operating status of each of the user terminal devices 102 to 105 from the terminal operation retrieving unit 2702, it recognizes status information such as a work status or busyness of the user according to the application in use name or the operating status. In addition, if the image recognizing means 2706 receives an image or a moving image of a user from the image retrieving means 2703, it recognizes status information such as a presence status of the user around a user terminal device, a work status, busyness or the like. Then, the user status recognizing means 2707 recognizes status information such as a presence status and busyness of the user based on these recognition results. The recognized status information is sent to the status information generating means 303.

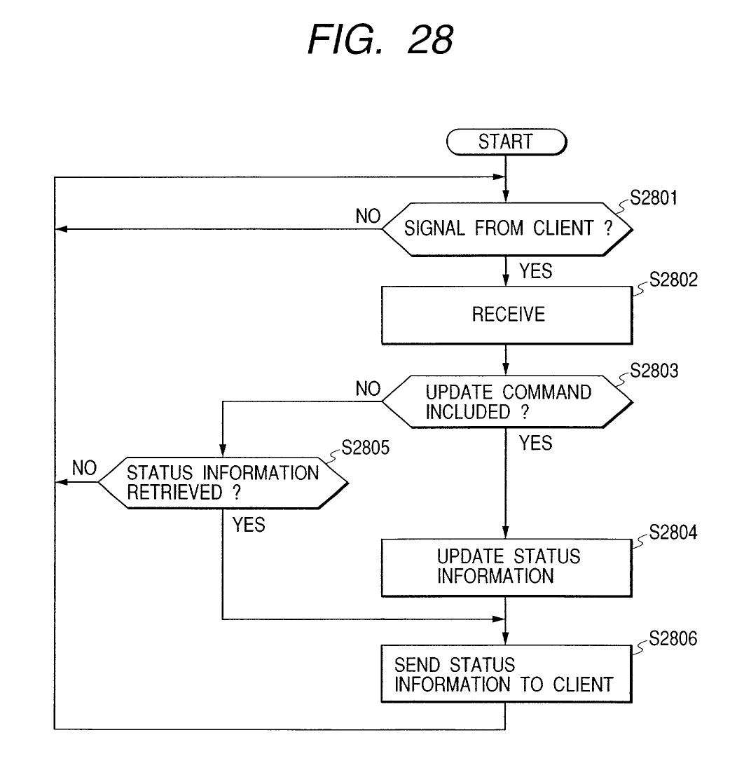

Procedures for processing status information sharing operations of the server S in this embodiment will be described with reference to a flow chart of FIG. 28. These processing programs are stored in a storage medium in the server device 101, respectively, and are executed by a CPU.

First, in step S2801, the server S determines whether or not a status information signal has been sent from the client X.

If it is determined in step S2801 that a status information signal has been sent from the client X, the status information receiving unit 709 receives the status information signal in step S2802.

In step S2803, the status information updating means 204 determines whether or not a status information update command is included in the received status information signal as a status information operating command.

If it is determined in step S2803 that a status information update command is included in the status information signal, the status information updating means 204 updates the status information stored in the status information table 205 based on status information included in the status information signal in step S2804.

In step S2806, the status information sending means 208 sends latest status information updated in step S2803 to the user terminal devices 102 to 105.

If it is determined in step S2803 that a status information update command is not included in the status information signal, the status information updating means 204 determines in step S2805 whether or not a status information retrieving command is included in the status information signal received in step S2802 as a status information operating command.

If it is determined in step S2805 that the status information retrieving command is included in the status information signal, the status information sending means 208 sends the latest status information stored in the status information table 205 to designated one(s) of the user terminal devices 102 to 105 in step S2806 in accordance with the status information retrieving command.

If it is determined in step S2805 that the status information retrieving command is not included in the status information signal, the processing returns to step S2801.

Processing of status information sharing operations of the client X in this embodiment is performed in the order indicated in a flow chart of FIG. 23.

In this embodiment, in step S2304, the status retrieving means 301, for example, retrieves a status of input in an input device such as a keyboard and a pointing device of a user from the input status retrieving means 2701, retrieves a name of an application used by the user and an operating status of each of the user terminal devices 102 to 105 from the terminal operation retrieving means 2702, and retrieves an image or a moving image of the user from the image retrieving means 2703. Then, the status retrieving means 301 transfers the retrieved various statuses concerning the user to the user status recognizing unit 302.

In step S2305, the user status recognizing means 302 recognizes status information such as a presence status of a user from various statuses concerning the suer received form the status retrieving unit 301. For example, the input status recognizing means 2704 receives a status of input in an input device such as a keyboard of the user from the input status retrieving means 2701, and recognizes status information such as a presence status and busyness according to the input status. In addition, the terminal operation recognizing means 2705 receives a name of an application used by the user and an operating status of each of the user terminal devices 102 to 105 from the terminal operation retrieving means 2702, and recognizes status information such as a work status and busyness of the user according to the application in use name or the operating status of each of the user terminal devices 102 to 105. In addition, if the image recognizing means 2706 receives an image or a moving image of the user from the image retrieving means 2703, it recognizes status information such as whether or not the user is seated around the user terminal device, a work status and busyness of the user. Then, the recognized status information is sent to the status information generating means 303. The status information generating means 303 having received the status information generates a status information signal including a status information operating command and the status information of the user.

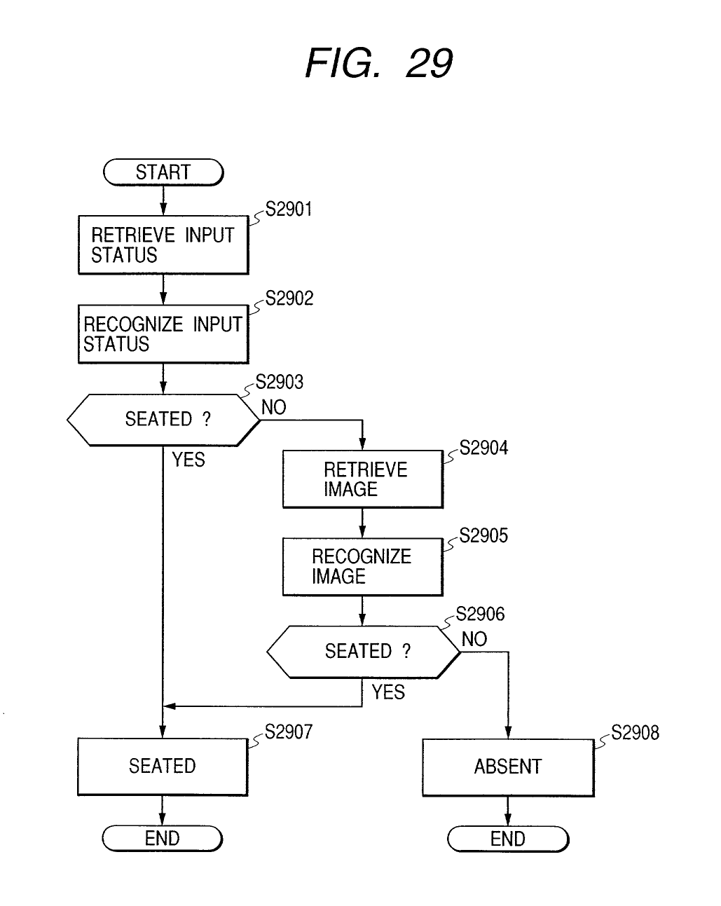

Procedures for processing operations with which the user status recognizing unit 302 recognizes a presence status of a user will now be described with reference to a flow chart of FIG. 29.

First, in step S2901, the input status retrieving unit 2701 retrieves a status of input in an input device such as a keyboard and a pointing device of each of the user terminal devices 102 to 105.

In step S2902, the input status recognizing means 2704 determines whether the input device is artificially operated by the user or is accidentally operated due to vibration from the input status retrieved in step S2901, and recognizes a presence status showing whether the user is seated or absent.

In step S2903, the input status recognizing means 2704 determines whether or not the presence status recognized in step S2902 is “seated”.

If it is determined in step S2903 that the user is seated, the user status recognizing means 302 recognizes that the user is seated in step S2907 and ends the processing.

If it is determined in step S2903 that the user is absent, the status retrieving unit 301 activates the image retrieving unit 2703 and retrieves an image of the user in step S2904.

In step S2905, the image recognizing means 2706 performs image recognition of the image retrieved in step S2904, and recognizes a presence status showing whether the user is seated or absent.

In step S2906, the image recognizing means 2706 determines whether or not the presence status recognized in step S2905 is “seated”.

If it is determined in step S2906 that the user is seated, the user status recognizing means 302 recognizes that the user is seated in step S2907 and ends the processing.

If it is determined in step S2906 that the user is absent, the user status recognizing means 302 recognizes that the user is absent in step S2908 and ends the processing.

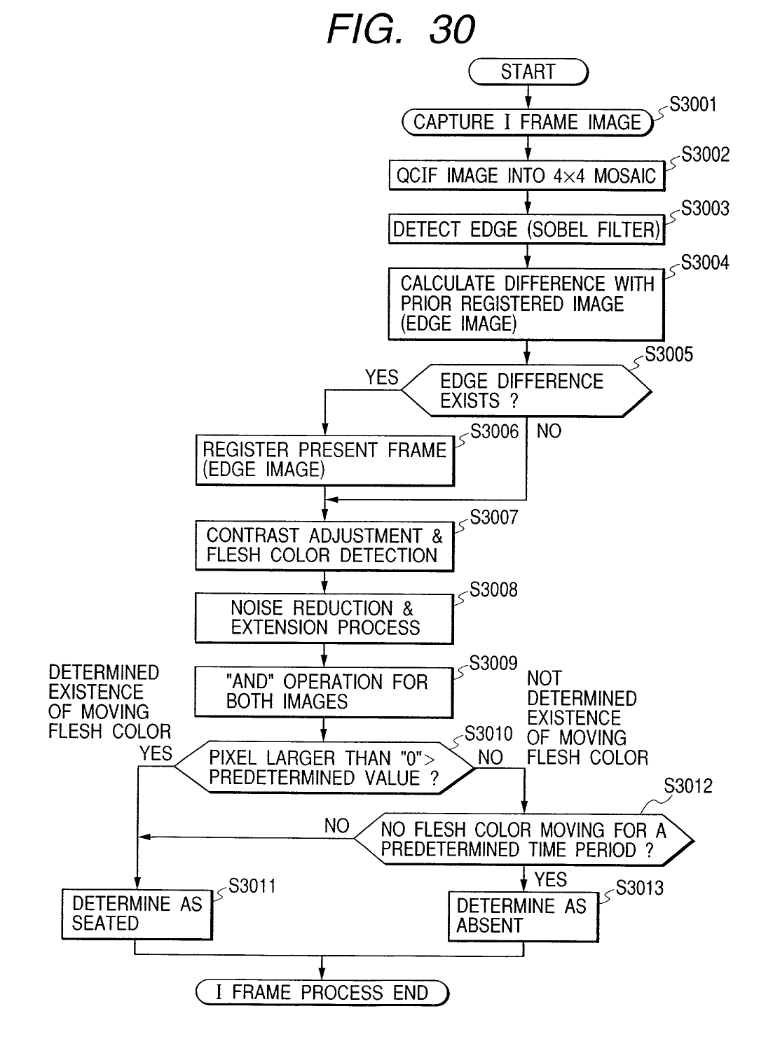

Procedures for processing operations with which the image recognizing means 2706 recognizes a presence status showing a user is seated or absent will be described with reference to a flow chart shown in FIG. 30.

First, in step S3001, the image recognizing means 2706 captures a user image retrieved by the image retrieving means 2703 as a digital image of the QCIF format (176×144 pixels).

In step S3002, the image recognizing means 2706 mosaics the digital image of the QCIF format captured in step S3001 with 4×4 pixels to convert it to an image of 44×36 pixels and compress it in order to accelerate image processing.

In step S3003, the image recognizing means 2706 detects an outline (edge image) of the image mosaicked and reduced in step S3002.

In step S3004, the image recognizing means 2706 retrieves a differential (edge differential image) between the image and the previously registered image (edge image) in order to detect a moving object in the image.

In step S3005, the image recognizing means 2706 determines whether there is an edge differential or not.

If it is determined in step S3005 that there is an edge differential , the image recognizing means 2706 registers a present frame (edge image) as a registered image in step S3006.

After the processing of step S3005 or if it is determined in step S3005 that there is no edge differential, the image recognizing means 2706 applies contrast adjustment to the image mosaicked and reduced in step S3002 in order to reduce effects of illumination, and detects flesh color pixels out of pixels in step S3007.

In step S3008, the image recognizing means 2706 applies noise reduction and extension processing to the image in which flesh color is detected in step S3007 in order to reduce effects of noises. Here, the image to which noise reduction and extension processing are applied is referred to as a flesh color image.

In step S3009, the image recognizing means 2706 combines the edge differential image retrieved in the above-mentioned step and the flesh color image.

In step S3010, the image recognizing means 2706 determines whether or not pixels having a pixel value larger than “0” are included in the retrieved image in the number larger than a predetermined number.

If it is determined in step S3010 that the number of pixels having a pixel value larger than “0” exceeds the predetermined number, the image recognizing means 2706 determines that there is a moving flesh color image in step S3011 and recognizes that the user is seated.

If it is determined in step S3011 that the number of pixels having a pixel value larger than “0” is less than the predetermined number, the image recognizing means 2706 determines that there is no moving flesh color image in step S3012 and counts time during which a flesh color image is not detected. Then, the image recognizing means 2706 determines whether or not the counted time exceeds predetermined time.

If a moving flesh color image is not detected for the predetermined time or more in step S3012, the image recognizing means 2706 determines that the user is absent in step S3013.

If a moving flesh color image is detected before the elapse of the predetermined time, the image recognizing means 2706 advances to the processing of step S3011. Then, after the processing of steps S3011 and S3012, this processing ends.

Further, the image recognizing means 2706 is also capable of performing status recognition of a user by using pattern matching.

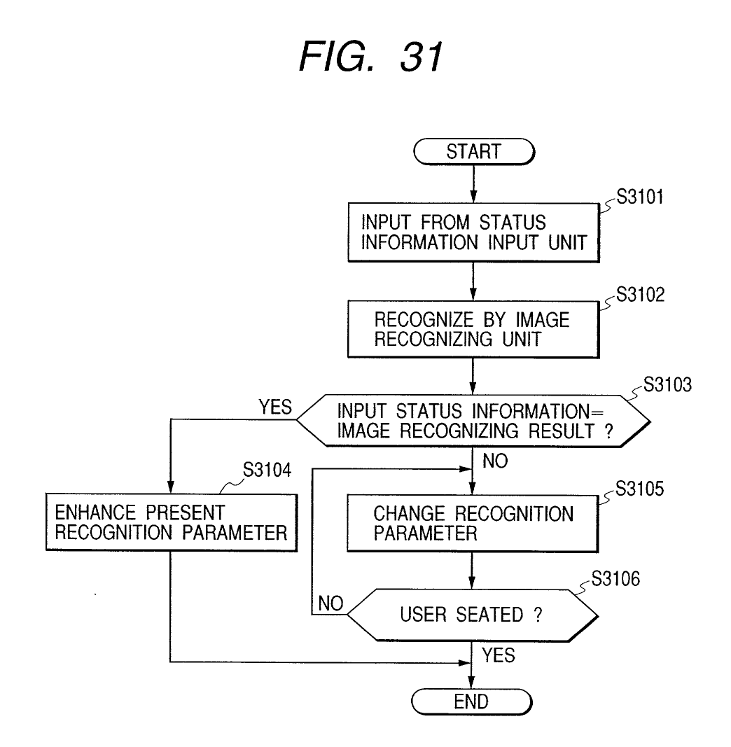

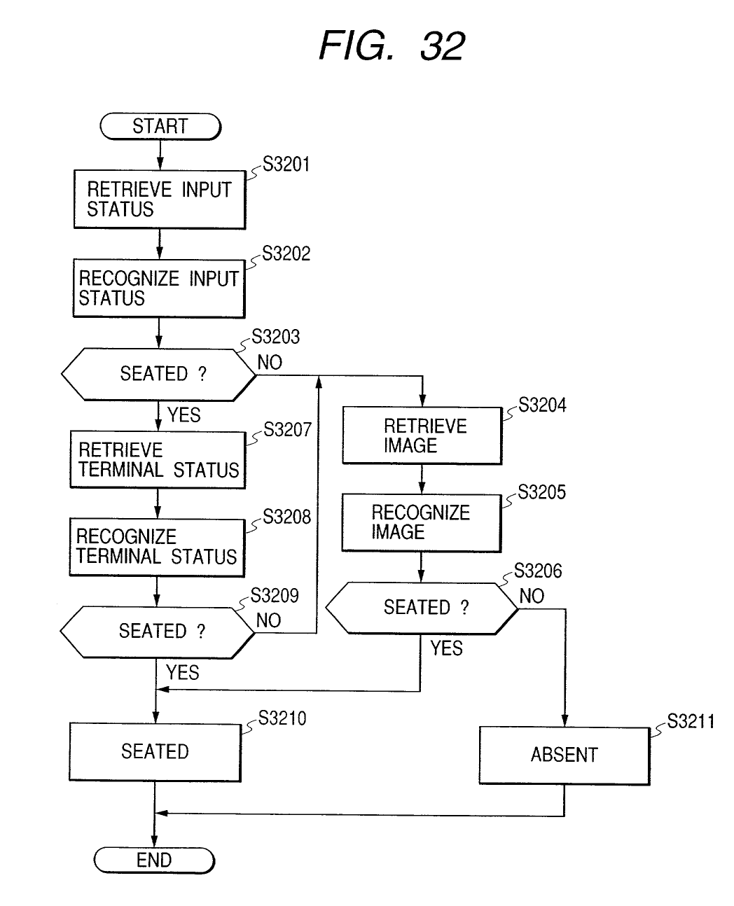

Procedures for processing operations with which the image recognizing means 2706 changes a parameter value for recognizing presence or absence of a user will now be described with reference to a flow chart shown in FIG. 31.

First, in step S3101, the image recognizing means 2706 confirms status information inputted by a user in the status information input means 306, which indicates that the user is seated.

In step S3102, the image recognizing means 2706 confirms the recognized status information based on the information retrieved from the image retrieving means 2703.

In step S3103, the image recognizing means 2706 determines whether or not the status information recognized in step S3101 and the status information recognized in step S3102 coincide with each other. That is, the image recognizing means 2706 determines whether or not the status information recognized in step S3102 also indicates that the user is seated.

If it is determined in step S3103 that the status information recognized in step S3101 and the status information recognized in step S3102 coincide with each other, the image recognizing means 2706 determines that image recognition has been correctly performed and changes a present value of a parameter used for image recognition such that recognition is improved in step S3104. Further, if a value of a parameter used in this image recognition is changed, the parameter value may be changed by enhanced training or a genetic algorithm in a neural network.

If it is determined in step S3103 that the status information recognized in step S3101 and the status information recognized in step S3102 do not coincide with each other, the image recognizing means 2706 determines that image recognition has been incorrectly performed and changes a present value of a parameter used in image recognition until image recognition is correctly performed in step S3105. Further, if a value of a parameter used in image recognition is changed in step S3105, the parameter value may be changed by enhanced training or a genetic algorithm in a neural network. In addition, since it is possible that a user exists outside an area in which a user can be photographed by the image retrieving means 2703, the image recognizing means 2706 may confirm with a user if the user is out of the area in which a user can be photographed.

In step S3105, when the image recognizing means 2706 confirms in step S3106 that it is correctly determined that a user is seated, it ends the processing for changing a parameter value.

As described above, since status information of a user is recognized from a status of inputting in an input device of a user terminal device by a user and image data photographed by image retrieving means, status information of higher recognition accuracy can be shared in this embodiment. In addition, it is also possible to automatically change a parameter in image recognition adaptably to a value with which higher recognition accuracy is realized.

Seventh Embodiment

In this embodiment, procedures for processing operations for recognizing presence or absence of a user by the user status recognizing means 302 will be described.

First, in step S3201, the status retrieving means 301, which is activated by the status information generating means 303 in order to retrieve status information of a user, retrieves a status of inputting in an input device such as a keyboard and a pointing device connected to each of the user terminal devices 102 to 105 by the user.

In step S3202, the user status recognizing means 302 recognizes whether the input device is artificially operated by the user or is accidentally operated due to vibration or the like in retrieving the input status in step S3201.

In step S3203, the user status recognizing means 302 determines whether the user is seated or not based on the recognition in step S3202.

When it is determined in step S3203 that the user is seated, the user status recognizing means 302 activates the terminal operation retrieving means 2702, and retrieves a name of an application used by the user and a terminal operating status such as an operating status of the application.

In step S3208, the user's status recognizing means 302 determines whether or not the user inputs an instruction with an intension of artificially operating each of the user terminal devices 102 to 106 based on the terminal operating status retrieved in step S3207.

In step S3209, the user's status recognizing means 302 determines whether or not the user is seated based on the recognition in step S3208.

If it is determined in step S3209 that the user is seated, the user status recognizing means 302 determines that the user is seated in step S3210, and ends the processing.

If it is determined in step S3203 or S3209 that the user is absent, the user status recognizing means 302 activates the image retrieving means 2703 and retrieves an image of the user in step S3204.

In step S3205, the user's status recognizing means 302 performs image recognition by the image recognizing means 2706 based on the image retrieved in step S3204.

In step S3206, the user status recognizing means 302 determines whether or not the user is seated based on the image recognition in step S3205.

If it is determined in step S3206 that the user is seated, the user's status recognizing means 302 determines that the user is seated and ends the processing.

If it is determined in step S3206 that the user is absent, the user's status recognizing means 302 determines that the user is absent and ends the processing.

As described above, since it is recognized whether or not a user inputs an instruction in an input device with an intension of artificially operating a terminal device, recognition with higher accuracy can be performed in this embodiment.

Eighth Embodiment

In this embodiment, procedures for processing operations will be described, with which the image recognizing means 302 stores or abandons a template image used for image recognition in recognizing a presence status of a user.

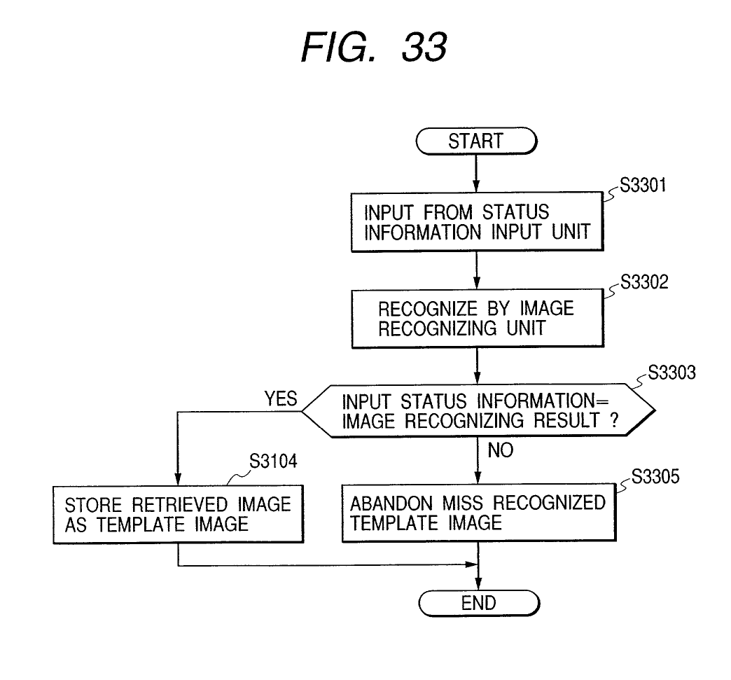

First, procedures for processing operations of this embodiment will be described with reference to a flow chart of FIG. 33. Further, in this embodiment, the image recognizing means 2706 performs operations for storing or abandoning user image data retrieved by the image retrieving means 2703 as a template image used in image recognition.

In step S3301, the image recognizing means 2706 confirms the status information inputted in the status information input unit 806 by the user.

In step S3302, the image recognizing means 2706 applies image recognition to the image retrieved from the image retrieving means 2703 by pattern matching to recognize the status information.

In step S3303, the image recognizing means 2706 determines whether or not the status information recognized in step S3301 and the status information recognized in step S3302 coincide with each other.

If it is determined in step S3303 that the status information recognized in step S3301 and the status information recognized in step S3302 coincide with each other, the image recognizing means 2706 determines that image recognition has been correctly performed, stores the presently retrieved user image as a template used in image recognition by pattern matching and also stores status information corresponding to this image in step S3204, and ends the processing.

If it is determined in step S3303 that the status information recognized in step S3301 and the status information recognized in step S3302 do not coincide with each other, the image recognizing means 2706 determines that image recognition has been incorrectly performed, abandons the template, which has been used in image recognition by pattern matching and mis-recognized, together with status information corresponding to the template image in step S3205, and ends the processing. Further, it is also possible that a user is outside an area in which a user can be photographed by the image retrieving means 2703, it may be confirmed here whether or not the user is outside the area in which a user can be photographed.

Since a template image used in image recognition by pattern matching is adaptably added or abandoned, image recognition with higher accuracy can be performed in this embodiment. In addition, even if a similar image is retrieved, image recognition can be performed immediately by pattern matching.

Ninth Embodiment

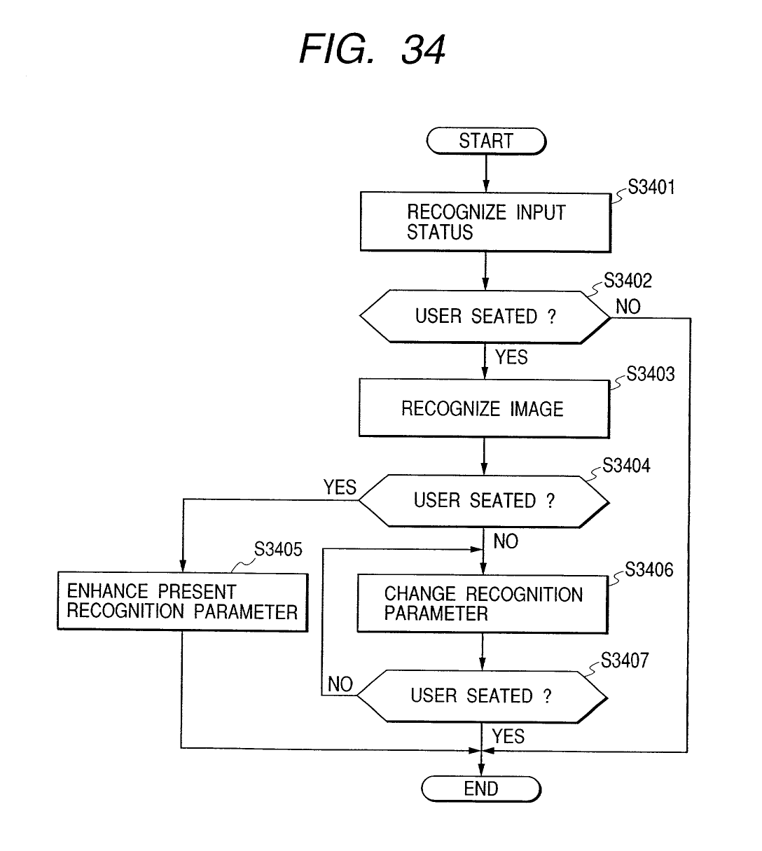

In this embodiment, procedures for processing operations with which the image recognizing means 2706 recognizes presence or absence of a user will be described with reference to a flow chart of FIG. 34.

First, in step S3401, the input status recognizing means 2704 recognizes a presence status of a user based on an input status retrieved from the input status retrieving means 2701.

In step S3402, the input status recognizing means 2704 determines whether or not the user is seated from the presence status recognized in step S3401. If it is determined in step S3402 that the user is not seated, the input status recognizing means 2704 ends the processing without doing anything.

If it is determined in step S3403 that the user is seated in step S3402, the image recognizing means 2706 recognizes a presence status of the user from the image received from the image retrieving means 2703.

In step S3404, the image recognizing means 2706 determines whether the user is seated or not from the presence status recognized in step S3403. Here, if it is recognized by the input status recognizing means 2704 that the user is seated in step S3402, it is highly likely that the user is seated, the image recognizing means 2706 is required to recognize that the user is seated in step S3403 as well.

Thus, if it is determined in step S3404 that the user is seated, the image recognizing means 2706 determines in step S3405 that image recognition has been correctly performed, and changes a value of a parameter used in the present image recognition such that recognition is improved. Then, the image recognizing means 2706 ends the processing. Further, if a value of a parameter used in this image recognition is changed, the parameter value may be changed by enhanced training or a genetic algorithm in a neural network.

On the other hand, it is determined in step S3404 that the user is absent, the image recognizing means 2706 determines in step S3406 that image recognition has been incorrectly performed, and changes a present value of a parameter used in the image recognition. Further, if a value of a parameter used in this image recognition is changed, the parameter value may be changed by enhanced training or a genetic algorithm in a neural network. In addition, since it is possible that the user is outside an area in which the user can be photographed by the image retrieving means 2703, it may be confirmed here whether the user is within the area in which the user can be photographed.

In step S3407, the image recognizing means 2706 determines whether the user is seated or not.

If it is determined in step S3407 that the user is absent, the processing returns to step S3406. That is, a parameter value is changed in step S3406 until image recognition is correctly performed (it is recognized that the user is seated).

If it is determined in step S3407 that the user is seated, the image recognizing means 2706 ends the processing.

In this embodiment, a status information sharing system can be realized which can automatically change a parameter in image recognition adaptably to a value with which higher accuracy of recognition can be realized.

Tenth Embodiment

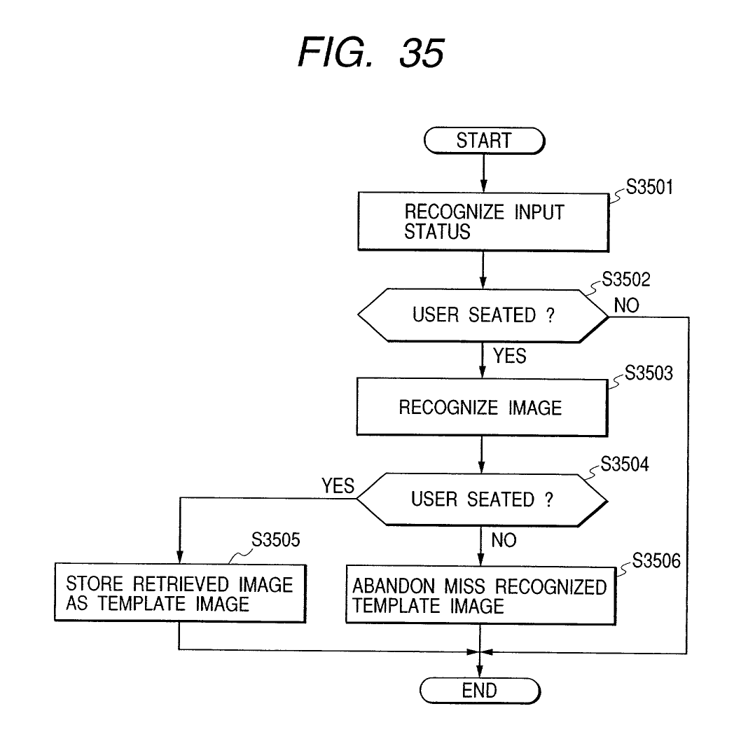

In this embodiment, procedures for processing operations for storing or abandoning a template image used in image recognition in recognizing presence or absence of a user will be described with reference to a flow chart of FIG. 35. Further, operations is shown in FIG. 35, with which the image recognizing means 2706 stores user image data received from the image retrieving means 2703 as a template image or abandons the image data.

First, in step S3501, the input status recognizing means 2704 recognizes a presence status of a user based on an input status received from the input status retrieving means 2701.

In step S3502, the input status recognizing means 2704 determines whether the user is seated or not from the presence status recognized in step S3501.

If it is determined in step S3502 that the user is not seated, the input status recognizing means 2704 ends the processing without doing anything.

If it is determined in step S3502 that the user is seated, the image recognizing means 2706 recognizes a presence status of the user in step s3503 based on the image received from the image retrieving means 2703.

In step S3504, the image recognizing means 2706 determines whether the user is seated or not from the presence status recognized in step S3503. Here, if it is recognized by the input status recognizing means 2704 in step S3502 that the user is seated, since it is highly likely that the user is seated, the image recognizing means 2706 is required to determined in step S3504 that the user is seated as well.

Thus, if it is determined in step S3504 that the user is seated, the image recognizing means 2706 determines that image recognition has been correctly performed, stores the retrieved user image as a template image used in image recognition by pattern matching and also stores status information corresponding to this image in step S3505. Then, the image recognizing means 2706 ends the processing.

On the other hand, if it is determined in step S3504 that the user is absent, the image recognizing means 2706 determines in step S3506 that image recognition has been incorrectly performed, abandons the template image, which has been used in image recognition by pattern matching and mis-recognized, together with status information corresponding to the template image in step S3506. Then, the image recognizing means 2706 ends the processing. Further, since it is also possible that a user is outside an area in which a user can be photographed by the image retrieving means 2703, it may be confirmed here whether or not the user is outside the area in which a user can be photographed.

Since a template image used in image recognition by pattern matching is adaptably added or abandoned according to a result of image recognition, image recognition with higher accuracy can be performed in this embodiment. In addition, when a similar image is retrieved, image recognition can be performed immediately by pattern matching.

Eleventh Embodiment

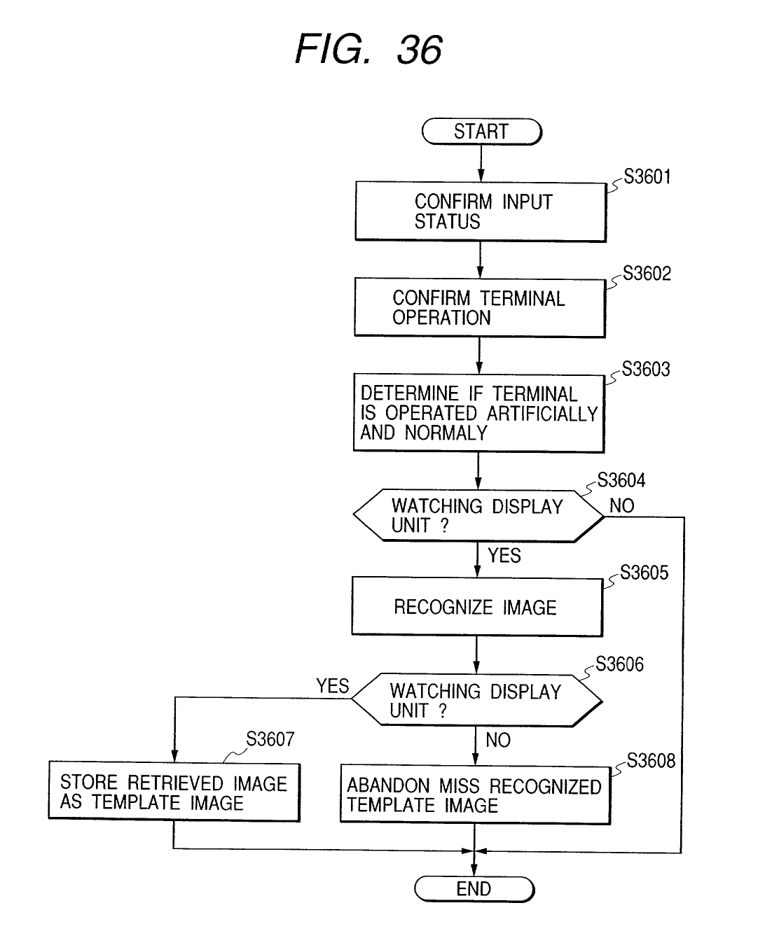

In this embodiment, procedures for processing operations for storing or abandoning a template image used in image recognition when the image recognizing means 2706 recognizes presence status of a user will be described with reference to a flow chart of FIG. 36.

In step S3601, the input status recognizing means 2704 recognizes whether the input status received form the input status retrieving means 2701 is continuous and artificial. For example, if a user operates a terminal device artificially, it is likely that the user, while looking at a display of the user's terminal device among the user terminal devices 102 to 105, operates an input device such as a pointing device to designate buttons or icons shown on the display, and causes each of the user terminal devices 102 to 105 to operate. Thus, the input status recognizing means 2704 can recognize whether or not the user looks at the display from the input status.

In step S3602, the terminal operation recognizing means 2705 retrieves an operating status of each of the user terminal devices 102 to 105 from the terminal operation status retrieving means 2702. Then, the terminal operation recognizing means 2705 recognizes if the retrieved terminal operating status is the status of a normal operation. For example, if each of the user terminal devices 102 to 105 operates normally in response to an operation of the input device, it is highly likely that the user looks at the display of the user's terminal device among the user terminal devices 102 to 105. Thus, the terminal operation recognizing means 2705 can recognize whether or not the user looks at the display from the terminal operating status.

In step S3603, the terminal operation recognizing means 2705 determines whether or not the input device is operated continuously and artificially and the terminal device operates normally in response to the operation from the recognition in step S3602.

In step S3604, the image recognizing means 2706 determines whether or not the user looks at the display of the user's terminal device among the user terminal devices 102 to 105. That is, the image recognizing means 2706 determines whether or not the user looks at the user's terminal device among the user terminal devices 102 to 105 according to the recognition results of the input status by the input status recognizing means 2704 and the recognition results of the operating status of the user terminal devices 102 to 105 by the terminal operation recognizing means 2705.

If it is determined in step S3604 that the user does not look at the display, the image recognizing means 2706 ends the processing without doing anything.

If it is determined in step S3604 that the user looks at the display, the image recognizing means 2706 performs image recognition by pattern matching in step S3605.

In step S3606, the image recognizing means 2706 determines whether or not it is recognized that the user looks at the display of the user terminal device by image recognition by pattern matching in step S3605.

If it is determined in step S3606 that the user looks at the display, the image recognizing means 2706 determines that image recognition has been correctly performed, stores the retrieved user image as a template image called “a user looks at a display” in order to use it in image recognition by pattern matching and also stores status information corresponding to this image in step S3607. Then, the image recognizing means 2706 ends the processing.

If it is determined in step S3606 that the user does not look at the display, the image recognizing means 2706 determines that image recognition has been incorrectly performed, and abandons the template image, which has been used in image recognition by pattern matching and mis-recognized, together with status information corresponding to the template image in step S3608. Then, the image recognizing means 2706 ends the processing. Further, since it is also possible that a user is outside an area in which a user can be photographed by the image retrieving means 2703, it may be confirmed here whether or not the user is outside the area in which a user can be photographed.

As described above, in this embodiment, it is possible to recognize whether or not a user looks at a display not only by image retrieving means such as a camera but also by input status recognizing means and terminal operation recognizing means.

In addition, it is possible to recognize with high accuracy whether or not a user looks at a display by adaptably adding or abandoning a template image for determining whether or not the user looks at the display using image recognition by pattern matching. In addition, when a similar image is retrieved, it is possible to immediately recognize whether the user looks at the display by pattern matching.

Further, although a presence status (seated or absent) of a user is recognized in the above-mentioned embodiment, the present invention is not limited to this, and a work status, busyness or the like may be recognized.

In addition, although in the above-mentioned embodiment recognition of status information such as a presence status of a user is performed by a user terminal device, it may be performed by a server device. In this case, processing of the user terminal device can be alleviated.

Twelfth Embodiment

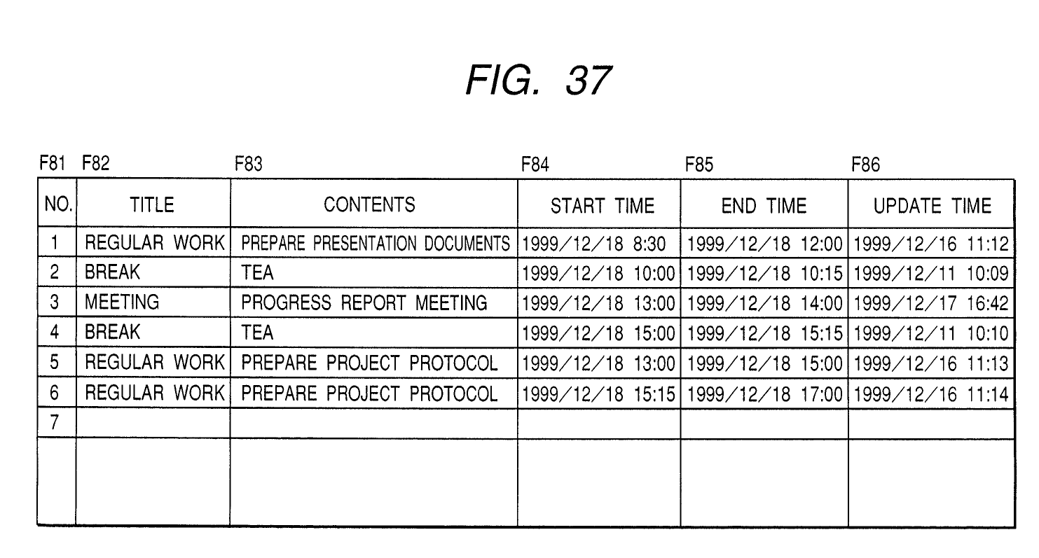

A table of FIG. 37 is a format of schedule information stored in the schedule information storing means 201. Further, the schedule information storing means 201 is included in the database means 1512.

In FIG. 37, reference numeral F81 denotes a number of a schedule record, reference numeral F82 denotes a title of a schedule, reference numeral F83 denotes contents of a schedule, reference numeral F84 is a start time of a schedule, reference numeral F85 is an end time of a schedule, and reference numeral F86 is a last update time of a schedule record.

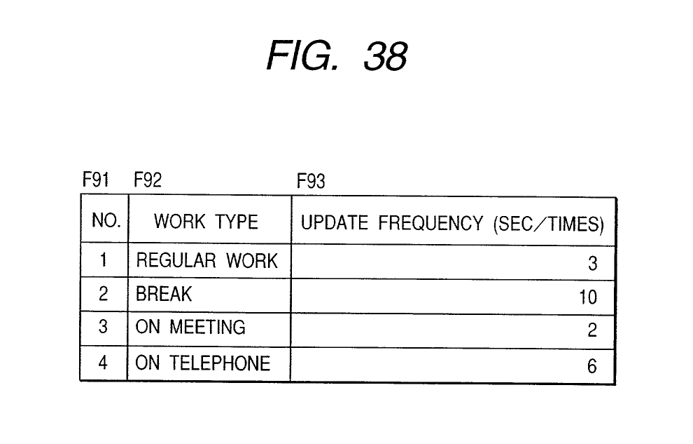

FIG. 38 is a table in which an update frequency for each work type saved in the database means 1512 is set. In FIG. 38, reference numeral F91 denotes a number of a record, reference numeral F92 denotes work type information, and reference numeral F93 denotes update frequency information. The table shown in FIG. 38 exists for each user registered in a status information sharing system of this embodiment, and setting in the table can be changed for each user.

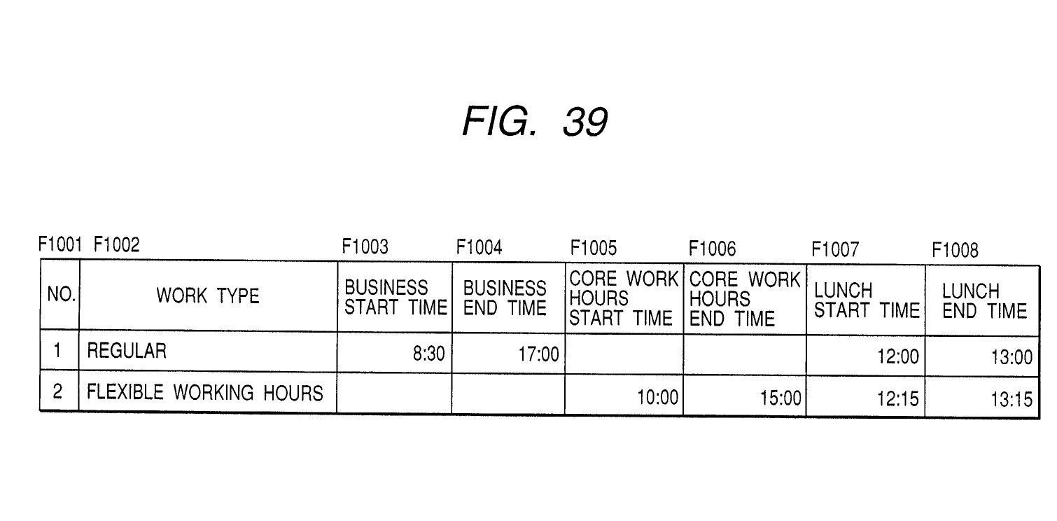

FIG. 39 is a table in which information concerning a work type of a user saved in the database means 1512 is set. In FIG. 39, reference numeral F1001 denotes a number of a record, reference numeral F1002 denotes work type information, reference numeral F1003 denotes business start time information, reference numeral F1004 denotes business time information, reference numeral F1005 denotes core work hours start time information, reference numeral F1006 denotes core work hours end time information, reference numeral F1007 denotes lunch start time information, and reference numeral F1008 denotes lunch end time information.

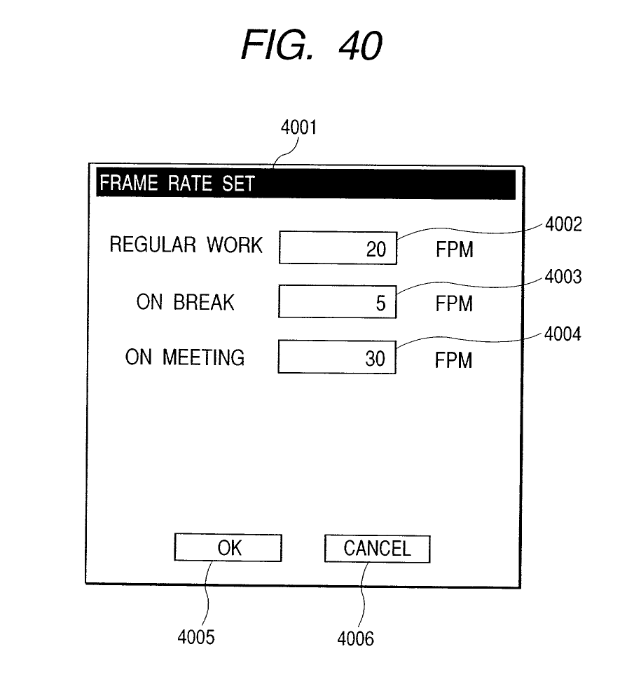

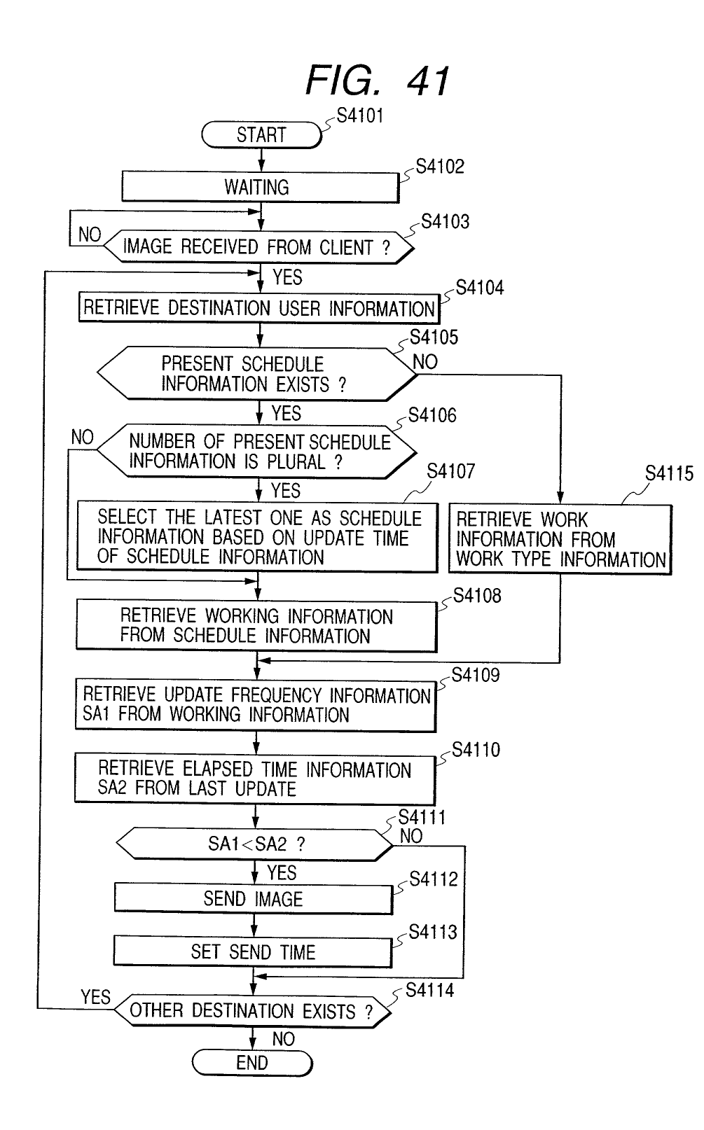

FIG. 40 illustrates a setting screen of a update frequency to be stored in the table of FIG. 38. Reference numeral 4001 denotes an update frequency (frame rate) setting screen to be indicated on the display 1604. Reference numeral 4002 denotes an update frequency input field in a regular work time, reference numeral 4003 denotes an update frequency input field on break, reference numeral 4004 denotes an update frequency input field on meeting, reference numeral 4005 denotes an OK button, and reference numeral 4006 denotes a cancel button. Each pieces of information set in the setting screen 4001 is stored in the table shown in FIG. 38. In addition, a default value set in a status information sharing system is stored in an item which is not inputted on this setting screen.

FIG. 31 is a flow chart showing procedures for processing operations when the server device 101 sends an image to the user terminal devices 102 to 105. This processing program is stored in a storage medium in the server device 101 and is executed by a CPU.

First, the server device 101 starts in step S4101.

In step S4102, the server device 101 waits until it receives an image from any one of the user terminal devices 102 to 105.

In step S4103, the server device 101 determines whether or not it has received an image from any one of the user terminal devices 102 to 105.

If it is determined in step S4103 that the server device 101 has received an image, the server device 101 retrieves information of one user in an identical office held in the server manager unit 1501 as destination user information in step S4104.

In step S4105, the server device 101 determines whether or not a present schedule exists in schedule information of a user registered in the schedule information storing means 201 of the database means 1512 based on the destination user information retrieved in step S4103.

If it is determined in step S4105 that a present schedule exists in the schedule information, the server device 101 determines in step S4106 whether or not there are a plurality of present schedules.

If it is determined in step S4106 that there are plurality of present schedules, the server device 101 selects schedule information with the latest update time information F86 as the present schedule in step 4107.

If it is determined in step S4106 that there is only one present schedule, the server device 101 advances to the processing of step S4108.

In step S4108, the server device 101 retrieves the title F82 of the selected present schedule as work information.

In step S4109, the server device 101 retrieves update frequency information of a work type corresponding to the work information retrieved in step S4108 as an update frequency interval SA1 (seconds) from the table (see FIG. 38) in which update frequencies corresponding to work types are set.

In step S4110, the server device 101 retrieves a differential between the last update time information held in the server manager means 1501 and a present time as lapsed time information SA2.

In step S4111, the server device 101 compares the update frequency interval SA1 and the lapsed time information SA2 and determines if SA1<SA2.

If it is determined SA1<SA2 in step S4111, the server device 101 sends an image to a destination user in step S4112.

In step S4113, the server device 101 updates the last update time information held in the server manager means 1501 to the present time.

In step S4114, the server device 101 determines whether other destination users exist or not based on the information held in the server manager means 1501.

If it is determined in step S4114 that other destination users exist, the server device 101 returns to the processing of step S4104.

If it is determined in step S4114 that other destination users do not exist, the server device 101 ends the processing.

In addition, if it is not determined SA1<SA2 in step S4111, the server device 101 advances to the processing of step S4114.

In addition, if it is determined in step S4105 that a present schedule does not exist, the server device 101 retrieves work information at the present time based on information of the present time and a work type of a user from the information table (see FIG. 39) concerning work types. Then, the server device 101 advances to the processing of step S4109.

In this embodiment, since distribution of an image is controlled according to a schedule existing in schedule information of a user, traffics of a user terminal device used by the user and loads on terminal processing ability can be alleviated.

Further, although the embodiments of the present invention have been described as above, the present invention is not limited to the configuration of these embodiment but can be applied to any configuration as long as the configuration can attain functions indicated in claims or functions attained by the configurations of the embodiments.

In addition, it is needless to mention that the present invention can also be applied to the case in which a storage medium that stores a program code of software for realizing the functions of the abovementioned embodiments is inserted in a system or a device to supply a program. In this case, the program code itself read out of the recording medium realizes a new function of the present invention, and the storage medium storing the program constitutes the present invention.

Program codes indicated in each flow chart of the above-mentioned embodiments are stored in a storage medium. As a storage medium for supplying the program codes, for example, a floppy disk, a hard disk, an ROM, an optical disk, a magneto-optical disk, a CD-ROM, a CD-R, a DVD, a magnetic tape and a nonvolatile memory card can be used.

In addition, it is needless to mention that the present invention includes the case in which the functions of the above-mentioned embodiments are realized not only by a computer executing a read-out program code but also by actual processing, a part or all of which is performed by an OS running on the computer based on an instruction of the program code.

Moreover, it is needless to mention that the present invention includes the case in which the functions of the above-mentioned embodiments are realized not only by the program code read out of the storage medium but also by actual processing, a part or all of which is performed by a CPU or the like provided in an extension function board inserted in a computer or a function extension unit connected to the computer.

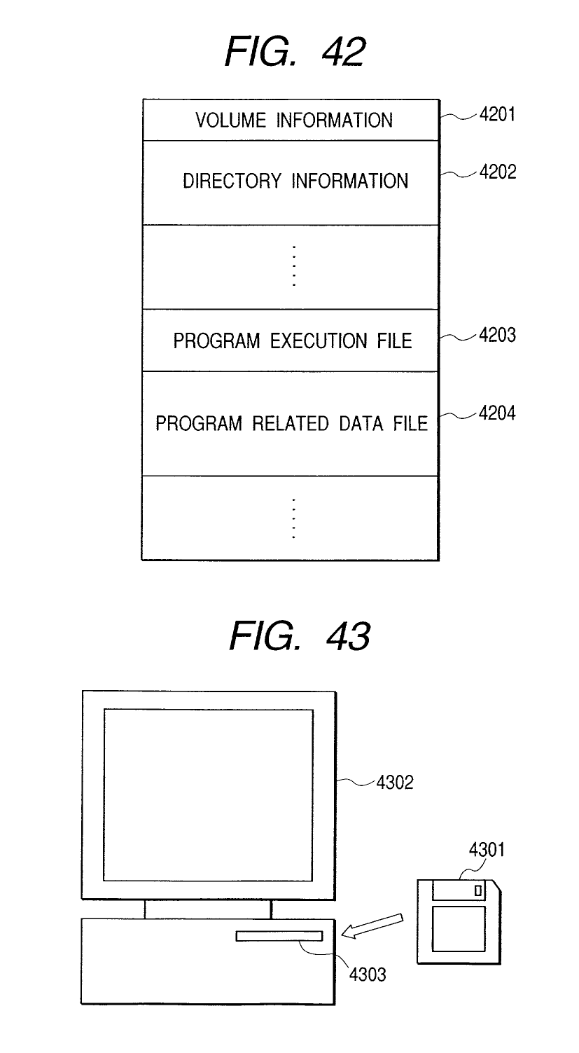

Further, FIG. 42 is an explanatory view showing an example of a configuration of contents stored in a storage medium storing a program in accordance with an embodiment of the present invention and related data. The storage medium is composed of stored contents such as volume information 4201, directory information 4202, a program execution file 4203 and a program related data file 4204. The program is coded based on the flow charts described in the above-mentioned embodiments.

FIG. 43 is an explanatory view showing a conceptual example for supplying a program in accordance with an embodiment of the present invention and related data are supplied from a storage medium to a device. The program and the related data are supplied by inserting a storage medium 4201 such as a floppy disk and a CD-ROM in a storage medium drive inserting opening 4303 provided in a device 4202. Thereafter, the program and the related data are once installed in a hard disk from the storage medium 1001 and then loaded in an RAM from the hard disk, or the program and the related data are loaded in an RAM directly without installing them in the hard disk. Thus, the program and the related data can be executed. In this case, if the program is executed in the status information sharing system of the above-mentioned embodiments, the program and the related data are supplied to each device forming the status information sharing system by the procedures shown in FIG. 43 or stored in each device in advance. Thus, the program can be executed in each device.

As many apparently widely different embodiments of the present invention can be made without departing from the spirit and scope thereof, it is to be understood that the invention is not limited to the specific embodiments thereof except as defined in the appended claims.

What is claimed is:

1. A status information sharing system for managing status information of users who handle user terminal devices, comprising:
user status recognizing means for recognizing statuses of the users who handle said user terminal device;
schedule information retrieving means for retrieving present schedules from schedule information of the users; and
status information generating means for generating status information of the users based on said statuses of the users recognized by said user status recognizing means and said present schedules retrieved by said schedule information retrieving means.

2. A system according to claim 1, wherein
said schedule information retrieving means retrieves last schedules from said schedule information, and said status information generating means generates status information of the users based on said present and last schedules retrieved by said schedule information retrieving means and said statuses of the users recognized by said user status recognizing means.

3. A system according to claim 1, wherein
said schedule information retrieving means retrieves next schedules from said schedule information, and said status information generating means generates status information of the users based on said present and next schedules retrieved by said schedule information retrieving means and said statuses of the users recognized by said user status recognizing means.

4. A system according to claim 1, wherein
said schedule information retrieving means retrieves past schedules from said schedule information, and said status information generating means generates status information of the users based on said present and past schedules retrieved by said schedule information retrieving means and said statuses of the users recognized by said user status recognizing means.

5. A system according to claim 1, further comprising:
schedule information updating means for updating said present schedules of said schedule information based on said status information generated by said status information generating means.

6. A system according to claim 1, further comprising:
counting means for counting a duration of a predetermined status if any of said statuses of the users recognized by said user status recognizing means is said predetermined status, wherein
said status information generating means generates status information set in advance according to the duration counted by said counting means.

7. User terminal devices that are capable of communicating with a server device managing schedules of users who handle the user terminal devices, comprising:
user status recognizing means for recognizing statuses of the users who handle the user terminal devices; and
status information receiving means for receiving status information, which is generated based on said statuses of the users recognized by said user status recognizing means, from said server device.

8. A server device that is capable of communicating with user terminal devices, comprising:
schedule information retrieving means for retrieving present schedules from schedule information of users who handle said user terminal devices;
user status retrieving means for retrieving statuses of the users; and
status information generating means for generating status information of the users based on said present schedules retrieved by said schedule information retrieving means and said statuses of the users retrieved by said user status retrieving means.

9. A control method for controlling user terminal devices that are capable of communicating with a server device for managing schedules of users who handle the user terminal device, comprising:
a user status recognizing step for recognizing statuses of the users who handle said user terminal device; and
a status information receiving step for receiving status information, which is generated based on said statuses of the users recognized by said user status recognizing step, from said server device.

10. A control method for controlling a server device that is capable of communicating with user terminal devices, comprising:
a schedule information retrieving step for retrieving present schedules from schedule information of users who handle said user terminal devices;
a user status retrieving step for retrieving statuses of the users; and
a status information generating step for generating status information of the users based on said present schedules retrieved by said schedule information retrieving step and said statuses of the users retrieved by said user status retrieving step.

11. A storage medium storing a program for controlling user terminal devices that are capable of communicating with a server device managing schedules of users who handle the user terminal devices, wherein the program comprising:
a user status recognizing step for recognizing statuses of the users who handle said user terminal device; and
a status information receiving step for receiving status information, which is generated based on said statuses of the users recognized by said user status recognizing step, from said server device.

12. A storage medium storing a program for controlling a server device that is capable of communicating with user terminal devices, wherein the program comprising:
a schedule information retrieving step for retrieving a present schedules from schedule information of users who handle said user terminal devices;
a user status retrieving step for retrieving statuses of the users; and
a status information generating step for generating status information of the users based on said present schedules retrieved by said schedule information retrieving step and said statuses of the users retrieved by said user status retrieving step.
